(19) United States
(12) Patent Application Publication
(10) Pub. No.: US 2022/0397458 A1
(43) Pub. Date: Dec. 15, 2022

(54) MASS SCREENING BIOLOGICAL DETECTION SOLUTIONS

(71) Applicant: Si-Ware Systems, Cairo (EG)

(72) Inventors: Yasser M. Sabry, Cairo (EG); Erik R. Deutsch, Brookline, MA (US); Bassam Saadany, Cairo (EG); Bassem A. Mortada, Cairo (EG); Mohamed H. Al Haron, Cairo (EG); Mazen Erfan, Cairo (EG); Moustafa Mohamed, Cairo (EG); Mohammed Sadek, Cairo (EG); Mostafa Medhat, Cairo (EG); Ahmed Shebl, Cairo (EG)

(21) Appl. No.: 17/575,591

(22) Filed: Jan. 13, 2022

Related U.S. Application Data
(60) Provisional application No. 63/209,366, filed on Jun. 10, 2021.
(60) Provisional application No. 63/211,507, filed on Jun. 16, 2021.

(51) Int. Cl. G01J 3/45; G01J 3/02; G01N 21/31

(52) U.S. Cl. CPC G01J 3/45; G01J 3/0272; G01N 21/31; G01J 3/0205; G01N 1/28

(57) ABSTRACT

Aspects relate to mechanisms for mass screening of samples. A portable laboratory device based on spectroscopic analysis of samples containing analytes under test can facilitate the mass screening. The portable laboratory device can include a sample head including a structure configured to facilitate application of the sample to the sample head and an optical measurement device including one or more light sources and a spectrometer. Light from the light source(s) incident on the sample may be directed to the spectrometer to obtain a spectrum of the sample. The optical measurement device can further include a data transfer device configured to provide the spectrum obtained by the spectrometer to a spectrum analyzer to produce a result from the spectrum.

### PRIORITY CLAIM

This application claims priority to and the benefit of Provisional Application No. 63/209,366, filed in the U.S. Patent and Trademark Office on Jun. 10, 2021, and Provisional Application No. 63/211,506, filed in the U.S. Patent and Trademark Office on Jun. 16, 2021, the entire contents of which are incorporated herein by reference as if fully set forth below in its entirety and for all applicable purposes.

### TECHNICAL FIELD

The technology discussed below relates generally to spectroscopic solutions for biological sample detection, and in particular to mechanisms for mass screening using scalable solutions.

### BACKGROUND

Infrared spectroscopy provides characterization of the vibrational and rotational energy levels of molecules in different materials. When the material is exposed to infrared light, absorption of photons occurs at certain wavelengths due to transitions between vibrational levels. Today, spectrometer instruments can be found in labs and industrial environments for material identification and/or quantification in different application areas. Various topologies for spectrometry instrumentation exist, including Fourier Transform InfraRed (FT-IR).

Infrared spectroscopy is a fast and low-cost mechanism for diagnosing biological samples, in general, and viral infections, specifically. The mechanism is based on the vibrations of the molecules and the interaction with infrared light. Each virus has a unique molecular structure. Each of these molecular structure components has its own spectral absorption signal in the infrared range, showing stronger absorption in the fingerprint mid-infrared region. The spectral absorption signal in the mid-infrared range is stronger since this is the fundamental region, while the signals in the near-infrared region (e.g., 7400 cm⁻¹ to 4000 cm⁻¹) are overtones and combinations of the fundamental ones. The mid-infrared spectrum at the fingerprint region are the bands corresponding to the main biomarker fragments. Based on this mechanism, various infrared absorption-based mechanisms for viral infection detection may be utilized.

For instance, near-infrared Raman spectroscopy has been used to spectrally differentiate between healthy human blood serum and blood serum with hepatitis C contamination in vitro. In addition, near-infrared spectroscopy has also been used to discriminate influenza virus-infected nasal fluids and to diagnose HIV-1 infection. Furthermore, the detection of malaria parasites in dried human blood spots using mid-infrared spectroscopy and regression analysis has been reported.

Near-infrared spectroscopy has also been used to detect viruses in animals, insects and plants. For instance, near-infrared spectroscopy has been used as a rapid, reagent-free, and cost-effective tool to noninvasively detect ZIKV in heads and thoraces of intact Aedes aegypti mosquitoes with prediction accuracies of 94.2% to 99.3% relative to polymerase chain reaction (PCR). In addition, near-infrared spectroscopy and aquaphotomics have been used as an approach for rapid in vivo diagnosis of virus infected soybean. Detection and quantification of poliovirus infection using FTIR spectroscopy in cell cultures have also been reported.

### SUMMARY

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an example, a portable laboratory device is disclosed. The portable laboratory device includes a sample head configured to receive a sample and including a structure configured to facilitate application of the sample to the sample head. The portable laboratory device further includes an optical measurement device including at least one light source configured to direct incident light towards the sample to produce input light, a spectrometer configured to receive the input light from the sample and to obtain a spectrum of the sample based on the input light, and a data transfer device configured to transfer the spectrum to a spectrum analyzer and to receive a result associated with the sample from the spectrum analyzer.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a spectrometer according to some aspects.

FIG. 2 illustrates an example of a workflow for building an AI engine according to some aspects.

FIG. 3 is a diagram illustrating an example of a portable laboratory device according to some aspects.

FIGS. 4A-4C are diagrams illustrating an example operation of a portable laboratory device according to some aspects.

FIG. 5 is a diagram illustrating another exemplary operation of a portable laboratory device according to some aspects.

FIG. 6 is a diagram illustrating another example of a portable laboratory device according to some aspects.

FIG. 7 is a diagram illustrating an example of a light source configuration of a portable laboratory device according to some aspects.

FIG. 8 is a diagram illustrating an example of a laboratory in a box including a portable laboratory device according to some aspects.

FIG. 9 is a diagram illustrating an example of a structure configured for use with a portable laboratory device according to some aspects.

FIG. 10 is a diagram illustrating another example of a structure configured for use with a portable laboratory device according to some aspects.

FIG. 11A is a diagram illustrating another example of a portable laboratory device according to some aspects.

FIG. 11B is a diagram illustrating an example of a vial holder configured for use with the portable laboratory device of FIG. 11A according to some aspects.

FIGS. 12A and 12B are diagrams illustrating examples of portable laboratory devices operating in reflection mode and trans-reflection mode according to some aspects.

FIG. 13 is a diagram illustrating an example of a portable laboratory device operating in a transmission mode according to some aspects.

FIG. 14 is a diagram illustrating another example of a portable laboratory device operating in a transmission mode according to some aspects.

FIG. 15 is a diagram illustrating an example of a portable laboratory device including a multi-path architecture according to some aspects.

FIG. 16 is a diagram illustrating another example of a portable laboratory device including a multi-path architecture according to some aspects.

FIG. 17 is a diagram illustrating another example of a portable laboratory device including a multi-path architecture according to some aspects.

FIGS. 18A and 18B are diagrams illustrating an example of a portable laboratory device including a structure of a sample head corresponding to a guiding spacer according to some aspects.

FIGS. 19A and 19B are diagrams illustrating examples of a cover slip according to some aspects.

FIG. 20 is a diagram illustrating an example of a portable laboratory device for performing measurements of multiple samples according to some aspects.

FIG. 21 is a diagram illustrating an example of a portable laboratory device for performing a measurement of a sample according to some aspects.

FIGS. 22A and 22B are diagrams illustrating other examples of a portable laboratory device including a structure of a sample head corresponding to a guiding spacer according to some aspects.

FIG. 23 is a diagram illustrating another example of a portable laboratory device including a structure of a sample head corresponding to a guiding spacer according to some aspects.

FIGS. 24A-24D are diagrams illustrating an example of a portable laboratory device configured to heat a sample according to some aspects.

FIG. 25 is a diagram illustrating another example of a portable laboratory device configured to heat a sample according to some aspects.

FIGS. 26A and 26B are diagrams illustrating an example of a portable laboratory device including functionalized cover slips according to some aspects.

FIG. 27 is a diagram illustrating an example measurement operation using a cuvette according to some aspects.

FIG. 28 is a diagram illustrating another example measurement operation using a cuvette according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosure relate to mechanisms for mass screening of samples for biological detection or biomarkers associated with certain diseases or other types of infection, such as, for example, virus infection, bacterial infection, parasite infection, or antibody titer. A portable laboratory device based on spectroscopic analysis of samples containing analytes under test can facilitate the mass screening. The portable laboratory device can include a sample head and an optical measurement device including one or more light sources operating in the infrared or near-infrared frequency range and a spectrometer. The spectrometer may include, for example, a micro-electro-mechanical systems (MEMS) interferometer.

The collected sample may be applied to the sample head either directly (e.g., via a cotton swab) or through a media, such as a viral transport media or other transport media (e.g., saline, phosphate buffer saline, minimum essential media, inactivation transport medium, etc.). The sample head may include a structure configured to facilitate application of the sample to the sample head. For example, the application of the sample may be aided with various tools for precise application of the sample in terms of volume and location on the sample head. In some examples, the structure may include a cavity for receiving a cover slip (or glass slip) containing the sample. In some examples, the cavity can include a first cavity for receiving a first cover slip and a second cavity positioned over the first cavity for receiving a second cover slip and the sample is contained between the first and second cover slips. Signal amplification may be achieved by multi-bounding of the light between the cover slips, controlling the angles of the cover slips used for sample application and for containing the sample or the use of functionalized cover slips. For example, the cavities may be rotated with respect to one another and/or inclined with respect to a plane of the optical measurement device for precise insertion of the cover slips and to control the length and interactions between the sample and the incident light from the light source(s).

Light from the light source(s) incident on the sample may be directed to the spectrometer to obtain a spectrum of the sample. The sample can be measured in a transmission, reflection, or trans-reflection mode based on the configuration of the light source(s) and the spectrometer. The portable laboratory device may further include a cover that may be positioned over the sample head to improve accuracy and avoid potential contamination. The cover may further be utilized to obtain a reference spectrum for calibration of the spectrometer. In some examples, the cover includes a reflecting surface for facilitating transmission mode and/or trans-reflection mode measurements. In some examples, the cover may further include an additional light source for conducting transmission mode measurements.

The same light source utilized for infrared spectroscopic measurement may also be used to heat and dry the sample, when needed. Additional light sources or heating mechanisms, such as thermoelectric heating and drying acceleration mechanisms may also be used to heat and dry the sample. Measurements from multiple samples may be obtained using an automated structure of the sample head.

The optical measurement device can further include a data transfer device configured to provide the spectrum obtained by the spectrometer to a spectrum analyzer, such as an artificial intelligence (AI) engine, to produce a result from the spectrum. For example, the result may be a positive or negative test result indicating the presence of infection. As another example, the result may be an antibody level for a particular type of infection. The AI engine may include a calibration model built based on measurements (e.g., spectrum) from a number of samples showing the presence or absence of different loads of the biological entity or analyte under analysis. For example, the spectrum may include measured absorption spectra (e.g., absorption signals) of the analyte under test. In some examples, the AI engine may include a plurality of calibration models, each constructed for a respective type of analyte under test and a respective media type of the sample. In some examples, the calibration model(s) may further be built using the portable laboratory device. In some examples, the AI engine may be contained within the portable laboratory device. In other examples, the AI engine may be a cloud-based AI engine. In this example, the data transfer device may include a wireless transceiver configured to transmit the spectrum to the AI engine via a wireless communication network.

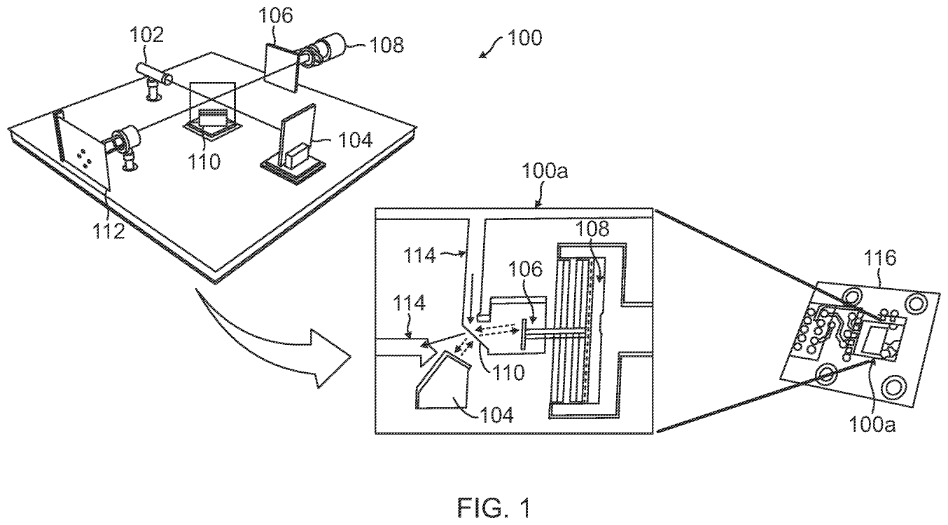

FIG. 1 is a diagram illustrating a spectrometer 100 according to some aspects. The spectrometer 100 may be, for example, a Fourier Transform infrared (FTIR) spectrometer. In the example shown in FIG. 1, the spectrometer 100 is a Michelson FTIR interferometer. In other examples, the spectrometer may include an FTIR Fabry-Perot interferometer.

FTIR spectrometers measure a single-beam spectrum (power spectral density (PSD)), where the intensity of the single-beam spectrum is proportional to the power of the radiation reaching the detector. In order to measure the absorbance of a sample, the background spectrum (i.e., the single-beam spectrum in absence of a sample) may first be measured to compensate for the instrument transfer function. The single-beam spectrum of light transmitted or reflected from the sample may then be measured. The absorbance of the sample may be calculated from the transmittance, reflectance, or trans-reflectance of the sample. For example, the absorbance of the sample may be calculated as the ratio of the spectrum of transmitted light, reflected light, or trans-reflected light from the sample to the background spectrum.

The interferometer 100 includes a fixed mirror 104, a moveable mirror 106, a beam splitter 110, and a detector 112 (e.g., a photodetector). A light source 102 associated with the spectrometer 100 is configured to emit an input beam and to direct the input beam towards the beam splitter 110. The light source 102 may include, for example, a laser source, one or more wideband thermal radiation sources, or a quantum source with an array of light emitting devices that cover the wavelength range of interest.

The beam splitter 110 is configured to split the input beam into two beams. One beam is reflected off of the fixed mirror 104 back towards the beam splitter 110, while the other beam is reflected off of the moveable mirror 106 back towards the beam splitter 110. The moveable mirror 106 may be coupled to an actuator 108 to displace the movable mirror 106 to the desired position for reflection of the beam. An optical path length difference (OPD) is then created between the reflected beams that is substantially equal to twice the mirror 106 displacement. In some examples, the actuator 108 may include a micro-electro-mechanical systems (MEMS) actuator, a thermal actuator, or other type of actuator.

The reflected beams interfere at the beam splitter 110 to produce an output light beam, allowing the temporal coherence of the light to be measured at each different Optical Path Difference (OPD) offered by the moveable mirror 106. The signal corresponding to the output light beam may be detected and measured by the detector 112 at many discrete positions of the moveable mirror 106 to produce an interferogram. In some examples, the detector 112 may include a detector array or a single pixel detector. The interferogram data verses the OPD may then be input to a processor (not shown, for simplicity). The spectrum may then be retrieved, for example, using a Fourier transform carried out by the processor.

In some examples, the interferometer 100 may be implemented as a MEMS interferometer 100a (e.g., a MEMS chip). The MEMS chip 100a may then be attached to a printed circuit board (PCB) 116 that may include, for example, one or more processors, memory devices, buses, and/or other components. In some examples, the PCB 116 may include a spectrum analyzer, such as an AI engine, configured to receive and process the spectrum. As used herein, the term MEMS refers to the integration of mechanical elements, sensors, actuators and electronics on a common silicon substrate through microfabrication technology. For example, the microelectronics are typically fabricated using an integrated circuit (IC) process, while the micromechanical components are fabricated using compatible micromachining processes that selectively etch away parts of the silicon wafer or add new structural layers to form the mechanical and electromechanical components. One example of a MEMS element is a micro-optical component having a dielectric or metallized surface working in a reflection or refraction mode. Other examples of MEMS elements include actuators, detector grooves and fiber grooves.

In the example shown in FIG. 1, the MEMS interferometer 100a may include the fixed mirror 104, moveable mirror 106, beam splitter 110, and MEMS actuator 108 for moveably controlling the moveable mirror 106. In addition, the MEMS interferometer 100a may include fibers 114 for directing the input beam towards the beam splitter 110 and the output beam from the beam splitter 110 towards the detector (e.g., detector 112). In some examples, the MEMS interferometer 104 may be fabricated using a Deep Reactive Ion Etching (DRIE) process on a Silicon On Insulator (SOI) wafer in order to produce the micro-optical components and other MEMS elements that are able to process free-space optical beams propagating parallel to the SOI substrate. For example, the electro-mechanical designs may be printed on masks and the masks may be used to pattern the design over the silicon or SOI wafer by photolithography. The patterns may then be etched (e.g., by DRIE) using batch processes, and the resulting chips (e.g., MEMS chip 100a) may be diced and packaged (e.g., attached to the PCB 116).

For example, the beam splitter 110 may be a silicon/air interface beam splitter (e.g., a half-plane beam splitter) positioned at an angle (e.g., 45 degrees) from the input beam. The input beam may then be split into two beams L1 and L2, where L1 propagates in air towards the moveable mirror 106 and L2 propagates in silicon towards the fixed mirror 104. Here, L1 originates from the partial reflection of the input beam from the half-plane beam splitter 110, and thus has a reflection angle equal to the beam incidence angle. L2 originates from the partial transmission of the input beam through the half-plane beam splitter 110 and propagates in silicon at an angle determined by Snell's Law. In some examples, the fixed and moveable mirrors 104 and 106 are metallic mirrors, where selective metallization (e.g., using a shadow mask during a metallization step) is used to protect the beam splitter 110. In other examples, the mirrors 104 and 106 are vertical Bragg mirrors that can be realized using, for example, DRIE.

In some examples, the MEMS actuator 108 may be an electrostatic actuator formed of a comb drive and spring. For example, by applying a voltage to the comb drive, a potential difference results across the actuator 108, which induces a capacitance therein, causing a driving force to be generated as well as a restoring force from the spring, thereby causing a displacement of moveable mirror 106 to the desired position for reflection of the beam back towards the beam splitter 110.

The unique information from the vibrational absorption bands of a molecule are reflected in an infrared spectrum that may be produced, for example, by the spectrometer 100 shown in FIG. 1. By applying spectral numerical processing and statistical analysis to a spectrum, the information in the spectrum may be identified or otherwise classified. The application of statistical methods to the analysis of experimental data is traditionally known as chemometrics, and more recently as artificial intelligence.

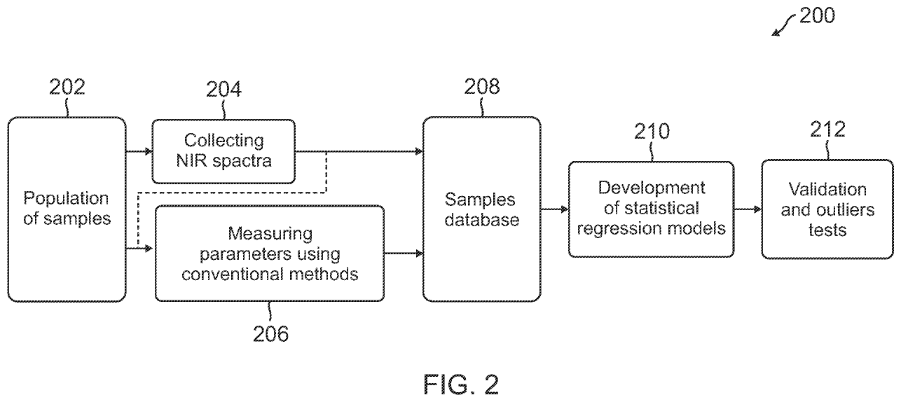

FIG. 2 illustrates an example of a workflow 200 for building an AI engine according to some aspects. To begin building the AI engine, a group or population of samples 202 is obtained for measurements by a spectrometer, such as the spectrometer 100 shown in FIG. 1, to produce spectra 204. At the same time, these samples 202 can also be measured by conventional methods and the values recorded as reference values 206. These reference values 206 together with the spectra 204 form a samples database 208 that is used to teach the AI engine (e.g., machine learning) how to interpret the spectra and transform the spectra to certain values (e.g., results). For example, the samples database 208 may be used in the development of statistical regression models (e.g., calibration models) 210 that may then be applied to a spectrum of a sample to produce a result (e.g., a positive or negative test result or antibody level) associated with the sample. Validation and outliers detection 212 of the test results may then be performed to refine the calibration model(s).

Since the spectrum produced by infrared (IR) spectroscopy are instantaneous, unlike conventional analysis methods, there is no need to wait for certain transformations (e.g., chemical transformations) to occur within the sample. Different physical and chemical parameters of the sample can be analyzed with a single scan. Therefore, although building an AI engine based on IR spectroscopy may be a complex process, the fast and simple results obtained using IR for material analysis justifies the effort to build the analysis models.

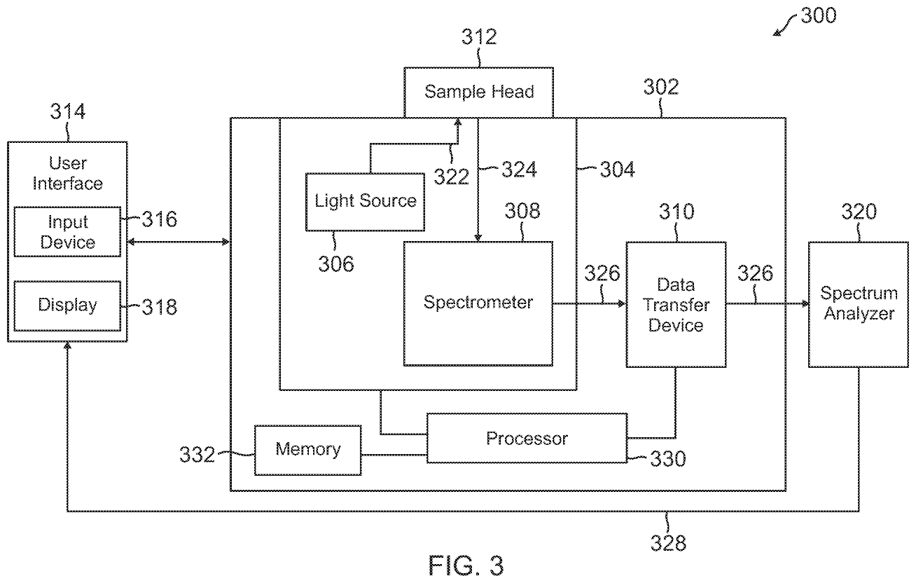

FIG. 3 is a diagram illustrating an example of a portable laboratory device 300 according to some aspects. The portable laboratory device 300 can be an efficient tool to contain the spread of the infection in a pandemic situation, for example COVID-19, and can facilitate the mobility of decision makers that may decide whether to provide or prevent access to a facility by various test subjects (e.g., human, animal, or plant subjects). The device 300 in the form of a laboratory in a box is compact, portable, and cheap and can be used for a mass screening campaign or screening for providing access to a certain facility or passing a gate. The analysis is ultra-rapid and very low cost. This includes work, entertainment, social, and residential facilities in addition to others.

The portable laboratory device 300 includes a housing 302 containing an optical measurement device 304, a data transfer device 310, a processor 330, and a memory 332. The processor 330 may include a single processing device or a plurality of processing devices. Such a processing device may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions. The memory 332 may be a single memory device, a plurality of memory devices, and/or embedded circuitry of the processor 330. Such a memory device may be a read-only memory, random access memory, volatile memory, non-volatile memory, static memory, dynamic memory, flash memory, cache memory, and/or any device that stores digital information, including instructions (e.g., code) that may be executed by the processor 330.

The optical measurement device 304 includes at least one light source 306 and a spectrometer 308. A sample head 312 configured to receive a sample containing an analyte under test is coupled to the housing 302. The sample head 312 may include a structure configured to facilitate application of the sample to the sample head 312 for interaction and alignment of the sample with the spectrometer 308. In addition, the structure may be configured to avoid contamination of the sample or contamination of the environment (e.g., the portable laboratory device and surrounding environment) from the sample. For example, the structure (not specifically shown) may be fixedly attached to the housing 302 or removably coupled to the housing 302. In some examples, the structure may be movable with respect to the housing 302. In some examples, the sample may be taken from a subject (e.g., human, animal, plant, etc.) and either applied directly to the sample head 312 (e.g., via the structure) or transferred to a transport media, such as a viral transport media or other transport media (e.g., saline, phosphate buffer saline, minimum essential media, inactivation transport medium, etc.), and then applied to the sample head 312 (e.g., via the structure).

The spectrometer 308 may include, for example, a MEMS FTIR based spectrometer, as shown in FIG. 1. The MEMS interferometer enables generating the spectrum in millisecond time scale since the moving micromirror is driven by a MEMS actuator. The light source(s) 306 may include, for example, a laser source or wideband source. The use of a laser source may enable measurements of Raman spectra of the samples. In some examples, the light source(s) 306 may be infrared or near-infrared light source(s). The light source(s) 306 can be configured to generate incident light 322 and to direct the incident light 322 towards a sample on the sample head 312 to produce input light 324. The spectrometer 308 can be configured to receive the input light 324 from the sample to obtain a spectrum 326 of the sample based on the input light. The input light 324 may be received by the spectrometer 308 in a transmission, reflection, or trans-reflection mode based on the configuration of the light source(s) 306 and the spectrometer 308. The spectrometer 308 may include a processor (not shown) configured to perform a Fourier transform of the interferogram to produce the spectrum 326, or the spectrometer 308 may output the interferogram to the processor 330 to produce the spectrum 326 (the former being illustrated in FIG. 3).

The portable laboratory device 300 further includes a user interface 314, which may include, for example, an input device 316 and a display 318. In some examples, the input device 316 and display 318 of the user interface 314 are implemented as a graphical user interface (GUI). The GUI may be attached to the housing 302 or may be implemented on a separate device, such as a wireless communication device (e.g., a cell phone). In some examples, the input device 316 may include a keyboard, mouse, selectable buttons, and/or other type of input device 316 either attached to an outside of the housing 302 or coupled via an external connector (e.g., a USB port) on the housing 302 or a wireless connection. In this example, the display 316 may be separate from the input device 314 and may be either attached to the housing 302 or coupled via an external connector or wireless connection.

The portable laboratory device 300 further includes a spectrum analyzer 320 coupled to the data transfer device 310. The spectrum analyzer 320 may include, for example, an AI engine. The spectrum analyzer 320 may include one or more processors for processing a spectrum 326 received from the spectrometer 308 and a memory configured to store one or more calibration models utilized by the processor in processing the spectrum. The spectrum analyzer 320 may be included within the housing 302 or may be a cloud-based device. For example, the one or more calibration models may be stored, for example, on a memory (e.g., memory 332) within the housing 302 or within the cloud. In examples in which the spectrum analyzer 320 is included within the housing 302, the data transfer device 310 can include a bus configured to transfer the spectrum produced by the spectrometer 308 to the spectrum analyzer 320. In examples in which the spectrum analyzer 320 is an external device (e.g., a cloud-based device), the data transfer device 310 can include a wireless transceiver configured to transmit the spectrum to the spectrum analyzer 320 via a wireless communication network.

The spectrum analyzer 320 (e.g., AI engine) can include one or more calibration models, each built for a respective type of media and for a respective type of analyte under test. In some examples, a sufficient number of negative and positive samples for a particular media and a particular analyte may be used to train the corresponding calibration model. The training samples may be handled in the same way the test samples are handled. The calibration model can further be built based on a certain number of units of the portable laboratory device 300 that covers the different conditions of the device and manufacturing variations to obtain a global calibration model. In addition, the developed calibration model can be adapted for any new units produced by techniques of model transfer.

In an example operation, the processor 330 can be configured to control the spectrometer 308 and the light source(s) 306 to initiate a measurement of a sample on the sample head 312. The processor 330 can control the light source(s) 306 to generate and direct the incident light 322 to the sample on the sample head 312. The input light 324 produced by interaction with the sample (e.g., via reflection, transmission, or trans-reflection of the incident light 322) is then input to the spectrometer 308 to produce a spectrum 326. In some examples, the processor 330 may initiate the sample measurement based on a sample measurement start command received via, for example, the input device 316. The sample measurement start command may further indicate a media type associated with the sample. For example, a user may select to start the sample measurement, and may further select a media type to be utilized in the analysis via the input device 316.

The processor 330 can further be configured to control the spectrometer 308 and the data transfer device 310 to transmit the spectrum 326 to the spectrum analyzer 320. The spectrum analyzer 320 is configured to process the spectrum 326 to produce a result 328 from the spectrum 326. In some examples, the calibration model in the spectrum analyzer 320 can analyze the spectrum 326 and produce a result (e.g., a value) representing the analyte under test in the form of a positive decision indicating the existence of the analyte under test or a negative decision indicating the absence of the analyte under test. The degree of positivity can also be produced by the calibration mode in the form of low, medium, and high. As another example, the result 328 may be an antibody level for a particular type of infection. In some examples, the spectrum 326 includes a measured absorption spectra and the spectrum analyzer 320 (e.g., AI engine) is configured to detect one or more analytes from absorption signals of the measured absorption spectra in the near-infrared frequency range. In some examples, absorption signals in the near-infrared region (frequency range) can be used to detect the analyte based on overtones and combinations of the fundamental vibrational modes. In addition, in the near-infrared region, sample preparation may not be required.

In some examples, the processor 330 may be configured to control the spectrometer 308 to perform multiple scans (e.g., multiple measurements) of the sample. The spectrometer 308 or the spectrum analyzer 320 may then be configured to average the multiple measurements (e.g., multiple interferograms or multiple spectrums) to improve the sensitivity of the result 328 produced by the spectrum analyzer 320.

The spectrum analyzer 320 is then configured to transmit the result 328 to the user interface 314 for display on the display 318. In some examples, the spectrum analyzer 320 may be configured to output the result 328 directly to the display 318 on the housing 302 of the portable laboratory device 300. In other examples, the spectrum analyzer 320 may be configured to transmit the result 328 to a wireless communication device including the display 318 via a wireless communication network (e.g., a cellular network, or a network employing IEEE 802.11 (Wi-Fi), IEEE 802.16 (WiMAX), Bluetooth, or other wireless system). In some examples, the result 328 may be utilized as a decision-making mechanism to authorize or prevent access of the tested subject to a facility or through a gate.

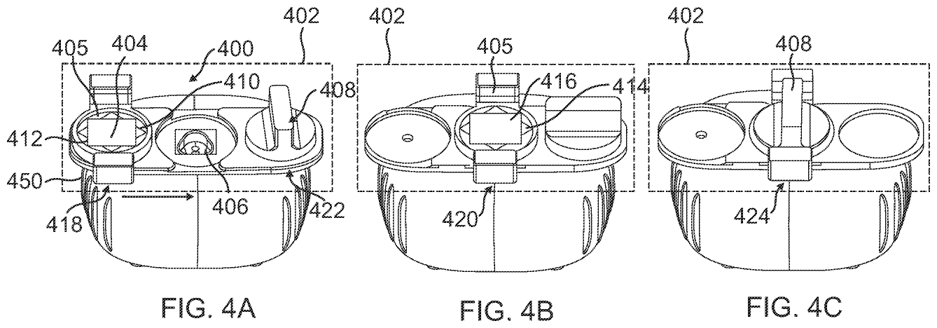

FIGS. 4A-4C are diagrams illustrating an example operation of a portable laboratory device 400 according to some aspects. The portable laboratory device 400 includes a housing 450 containing an optical measurement device (e.g., as shown in FIG. 3). The portable laboratory device 400 further includes a sample head 402 on the housing 450 configured to receive a sample (not illustrated). The sample head 402 includes various components on the surface of the housing 450 above the optical measurement device. For example, the sample head 402 includes a structure 405 configured to facilitate application of the sample to the sample head 402, an optical window 406 of the optical measurement device, and a cover 408. Here, the optical window 406 forms part of the optical measurement device and the sample head 402. The structure 405 includes hole 404, a first cavity 410 and a second cavity 412. The hole 404 may be utilized to precisely locate where to place the sample (e.g., a droplet).

As shown in FIGS. 4A and 4B, the first cavity 410 is configured to receive a first cover slip 414, such as a glass slide, on which the sample (e.g., the droplet) may be placed. The second cavity 412 is configured to receive an optional second cover slip 416 depending on the media type and corresponding viscosity of the droplet. For example, the second cover slip 416 may be inserted into the second cavity 412 above the first cover slip 414 containing the droplet. The second cover slip 416 may be inserted into the second cavity 412 to precisely control the interaction path length between the light and the droplet. In addition, the second cover slip 416 may prevent the evaporation of the sample during the analysis, which could lead to spread of a virus corresponding to the sample and/or a modification of the spectrum of the sample. The second cavity 412 may be rotated with respect to the first cavity (e.g., by 45 degrees) to facilitate precise insertion of the second cover slip 416 at a repeatable location and distance from the first cover slip 414.

The structure 405 of the sample head 402 is moveable from a first position 418 to receive the sample, as shown in FIG. 4A, to a second position 420 above the optical window 406, as shown in FIG. 4B. In the second position 420, the hole 404 is aligned with the optical window 406. The optical window 406 is positioned on the surface of the housing 450 to direct input light from the sample into a spectrometer of the optical measurement device. The spectrometer may correspond, for example, to the spectrometer shown in FIG. 1 and may be configured, for example, within the housing 450 as shown in FIG. 3. The optical window 406 may further be positioned on the surface of the housing 450 of the portable laboratory device 400 to direct incident light from at least one light source (e.g., as shown in FIG. 3) contained within the housing 440 towards the sample.

As further shown in FIGS. 4A and 4C, the cover 408 may be moved from a first position 422 while the portable laboratory device 400 is not in operation to a second position 424 while the portable laboratory device 400 is in operation. During operation of the portable laboratory device 400, incident light from at least one light source of the optical measurement device is directed towards the sample (e.g., towards the volume of the hole 404) in a reflective, transflective, or transmissive mode configuration. The scattered light from the sample is then coupled into the spectrometer as input light for conducting an optical measurement of the sample (e.g., by obtaining a spectrum of the sample that may be further processed). The cover 408 may be used to prevent interfering light from the outside environment and to trap the incident light from the at least one light source into a space between a top of the optical window 406 and the bottom of the cover 408.

In some examples, the bottom of the cover 408 may be a reflecting surface in a specular or diffuse reflection manner to enable specular/diffuse trans-reflectance measurements. In some examples, the bottom of the cover 408 may include a reference material for calibration of the spectrometer, including, for example, calibration of the x-axis of the wavelength and the y-axis of the absorbance. The bottom of the cover 408 can further include an additional light source for conducting transmission measurements.

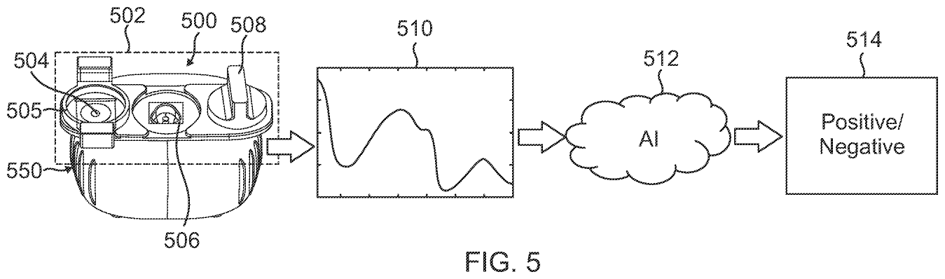

FIG. 5 is a diagram illustrating another example operation of a portable laboratory device 500 according to some aspects. The portable laboratory device 500 includes a sample head 502 configured to receive a sample 504. The sample head 502 includes a structure 505 moveable, as described in FIG. 4, from a first position to receive the sample 504 to a second position above an optical window 506 of the optical measurement device. In addition, a cover 508 may be placed over the structure 505 in the second position to conduct an optical measurement of the sample 504, as described in FIG. 4. For example, during operation of the portable laboratory device 500, a spectrometer within a housing 550 of the portable laboratory device 500 may be configured to obtain a spectrum 510 of the sample 504.

The spectrum 510 may be input to an artificial intelligence (AI) engine 512 configured to produce a result 514 associated with the spectrum 510. The result 514 may represent the analyte under test in the form of a positive or negative decision (value) indicating the presence or absence of the analyte under test in the sample 504. In some examples, the result 514 may include a degree of positivity (e.g., in the form of low, medium, or high). The AI engine 512 may be stored, for example, on the cloud or locally within the portable laboratory device 500 or another device in communication with the portable laboratory device 500.

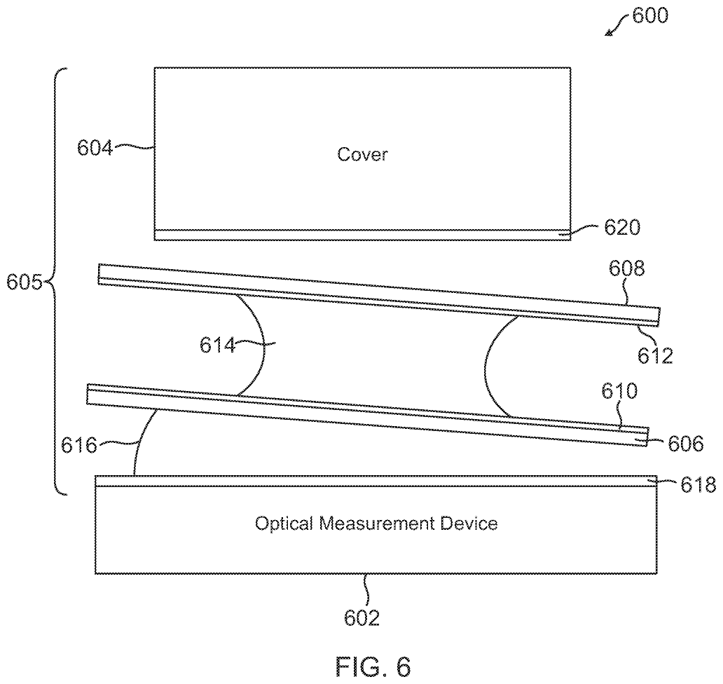

FIG. 6 is a diagram illustrating another example of a portable laboratory device 600 according to some aspects. The portable laboratory device 600 includes an optical measurement device 602 and a sample head 605. The sample head 605 includes a cover 604, similar to that illustrated in FIGS. 3-5. The sample head 605 further includes a first cavity 606 and a second cavity 608 positioned between the optical measurement device 602 and the cover 604. A first cover slip 610 may be inserted into the first cavity 606 and a second cover slip 612 may be inserted into the second cavity. A sample 614 (e.g., a droplet) is contained between the first and second cover slips 610 and 612. In addition, the first and second cavities 606 and 608 may each have an inclination angle 616 with respect to a plane of an optical window 618 of the optical measurement device 602 to control the multiple reflections, or etaloning, that can occur within the cover slips 610 and 612, between the cover slips 610 and 612, between the first cover slip 610 and the optical window 618, or between the second cover slip 612 and the cover 604. The multiple reflections between the two cover slips 610 and 612 may enhance the interaction between the incident light and the droplet 614. In some examples, a bottom surface 620 of the cover 604 may include a reflecting surface or a reference material, as described above.

In some examples, instead of inclining the cavities 606 and 608, the cover slips 610 and 612 may be wedged cover slips 610 and 612 that produce the desired inclination angle 616. In some examples, the inclination (or tilt) angle 616 may vary between the cavities 606 and 608 or cover slips 610 and 612. For example, the first cavity 606 (or first cover slip 610) may have a first inclination angle and the second cavity 608 (or second cover slip 612) may have a second inclination angle different than the first inclination angle. In some examples, the volume of the droplet 614 can also affect the amount of input light coupled into the spectrometer of the optical measurement device 602 and the amount of absorbed light. For example, the volume of the droplet 614 may be 5 μL or less to maximize the reflectance spectra. Larger volumes (e.g., tens of μL) of droplets 614 may also be used, depending on the desired results.

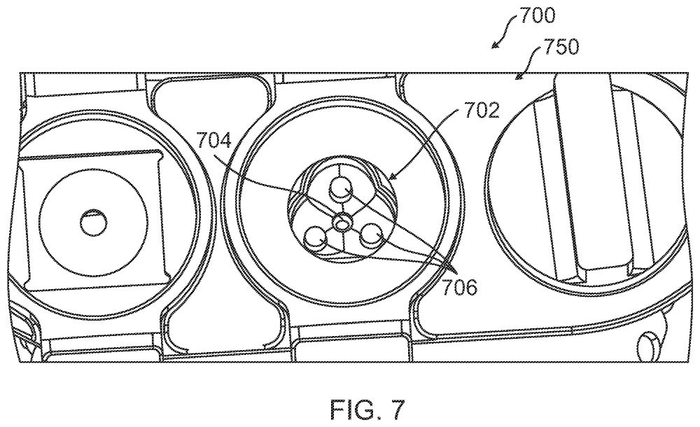

FIG. 7 is a diagram illustrating an example of a light source configuration of a portable laboratory device 700 according to some aspects. In the example show in FIG. 7, the portable laboratory device 700 includes an optical window 702 with an optical aperture 704 configured to direct input light into a spectrometer (not shown). The optical aperture 704 may have a size (e.g., radius) configured to reduce stray light and maximize the signal from the sample, thus improving detectivity by reducing the shot noise of the infrared detector.

The portable laboratory device 700 further includes a plurality of light sources 706 within a housing 750 of the portable laboratory device adjacent to the optical window 702 to direct incident light through the optical window to a sample on the sample head (e.g., when the sample head is positioned over the optical window 702). By using multiple light sources 706, the optical throughput and detection sensitivity of the portable laboratory device 700 may be increased. The light sources 706 may be arranged in a triangular, circular or star configuration to facilitate scanning of the sample in a repeatable manner and to radiate incident light with an angle on the sample and cover slips to prevent fringing effects.

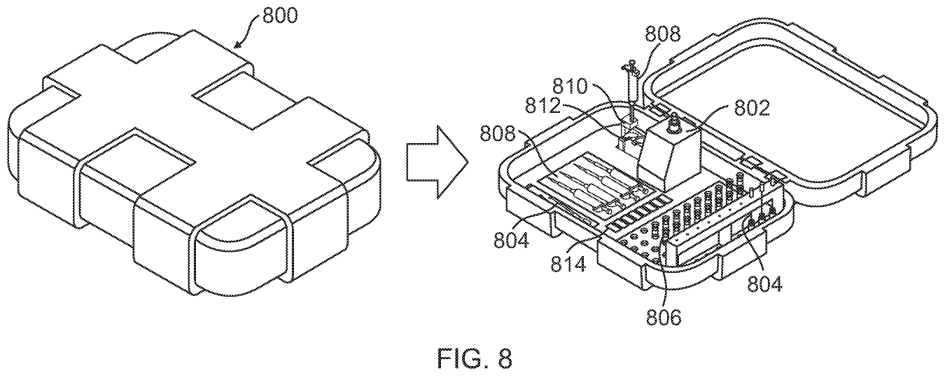

FIG. 8 is a diagram illustrating an example of a laboratory in a box 800 including a portable laboratory device 802 according to some aspects. The portable laboratory device 802 includes the sample head 812, an optical measurement device (e.g., including light source(s) and spectrometer) and a data transfer device, and may further include a local spectrum analyzer and user interface (e.g., display and input device(s)) or may include a transceiver and antenna configured for communicating with an external spectrum analyzer (e.g., AI engine including one or more calibration models) and/or user interface (e.g., on a cellular device) via a wireless communication network, as shown and described in FIGS. 3-7.

The laboratory in a box 800 may further include, for example, a plurality of collection tools 804 (e.g., nasal or saliva swabs, finger sticks, urine or stool sample containers, hair sample collection tools, etc.), a plurality of vials 806, a plurality of pipettes 808, and an application tool 810 (e.g., a swab holder or pipette holder, the latter being illustrated). In some examples, the application tool 810 may form part of the structure of the sample head. In some examples, each of the vials 806 may include a respective media for the biological sample or one or more separate containers including respective media types may be provided in the laboratory in a box 800. In some examples, the media may include receptors/reagents for the biological sample. The laboratory in a box 800 may further include a plurality of cover slips (e.g., glass slides) 814. In some examples, the cover slips 814 may include functionalized cover slips for the biological sample to be detected.

The laboratory in a box 800 may further include other components, such as a shaker (e.g., a vortex mixer), filter tips, or filtration mechanism for sample pre-concentration. For example, a sample collected using a swab 804 may be transferred to a vial 806 containing a media. Here, various types of media can be used, such as saline, phosphate buffer saline, minimum essential media, inactivation transport media, universal transport media, and viral transport media. The pH level of the media may be kept within a pre-configured range. As described above, each media may have a calibration model built for it and a user can select the calibration model on the user interface (e.g., on the portable laboratory device 702 or an external device controlling the portable laboratory device 702). The transfer may include, for example, immersion of the swab 804 into a specified volume of the media in the vial (tube) 806 and shaking of the tube to accelerate the transfer of the sample (e.g., a virus) to the media. Different mechanisms of shaking may be used. An example is a vortex mixer for mixing laboratory samples in test tubes using a mechanism to agitate samples and encourage reactions or homogenization, with a high degree of precision. A pre-concentration step may also be applied on the sample, such as centrifugation or the use of a membrane filter or particle trapping filter with suitable pore size for virus trapping.

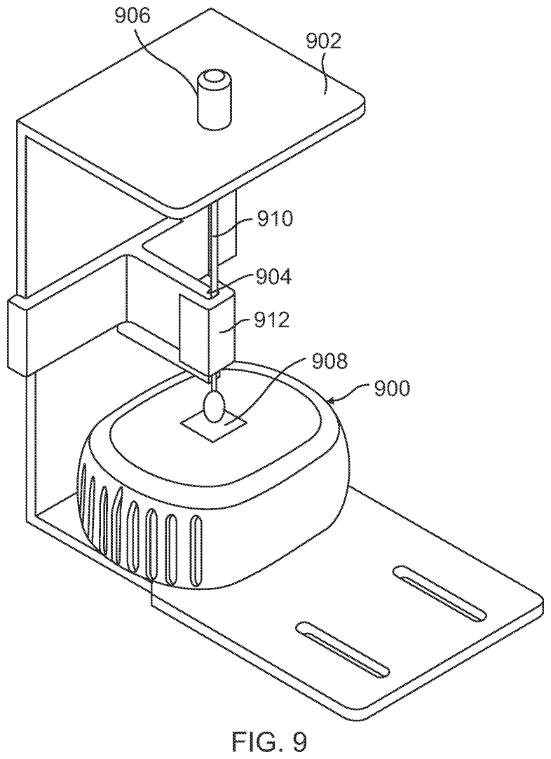

FIG. 9 is a diagram illustrating an example of a structure of a sample head configured for use with a portable laboratory device 900 according to some aspects. In the example shown in FIG. 9, the structure includes a swab holder 902. In some examples, the swab holder 902 may be fixedly attached to the portable laboratory device 900. In other examples, the swab holder 902 may be removably attached to the portable laboratory device 900. The swab holder 902 includes a hole 906 on a top surface and groove 904 in an extended portion within which a swab 910 may be inserted. The swab 910 may be secured in the swab holder 902 using a clasp 912. The swab holder 902 is configured to align the swab 910 with an optical window 908 of the portable laboratory device 900 and is utilized to ensure repeatability of the position of the swab 910 with respect to the optical window 908. In some examples, a cover slip may be inserted between the optical window 908 and the swab 910 (e.g., as shown in FIG. 4B). In the absence of a cover slip, the optical window 908 may be cleaned and dried between sample testing. In this example, the sample may be applied directly on the optical window 908. For example, the sample may be applied through the hole on the sample head, not shown for simplicity, when the sample head is positioned over the optical window 908. As another example, at least a portion of the optical window 908 may correspond to the sample head and the swab holder 902 may align the swab 910 with the portion of the optical window 908.

In an exemplary operation, in diffuse reflection, a spectrum may be measured in the NIR spectral range. A first spectrum of a dry swab 910 may be taken by the portable laboratory device 900 as a background before each measurement by inserting the swab 910 through the hole 906 in the swab holder 902 and securing the swab with the clasp 912. The swab may then be used to collect the sample (e.g., from saliva, nasopharyngeal, oropharyngeal, or a bodily fluid in general). Collection of blood using finger pricking or other suitable mechanism is also possible. The swab 910 may then be inserted into the swab holder 902 and secured to obtain a second spectrum of the swab with the sample.

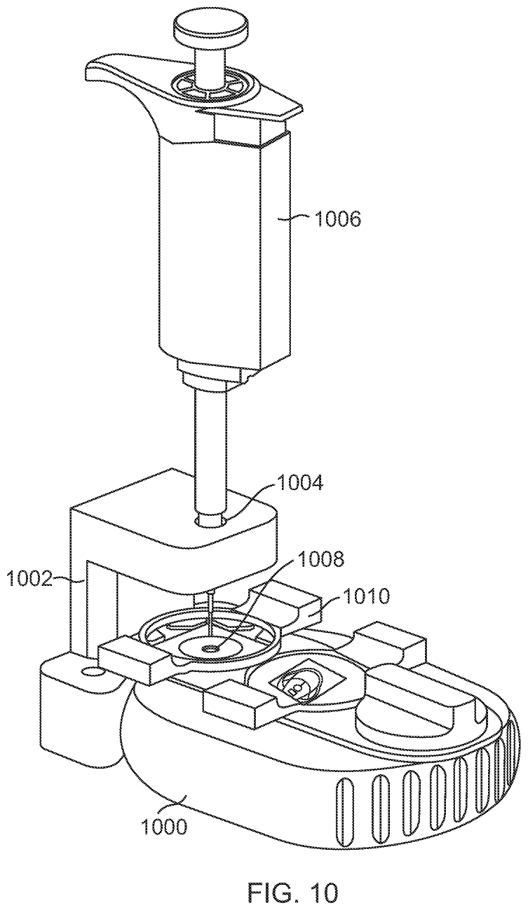

FIG. 10 is a diagram illustrating another example of a structure of a sample head configured for use with a portable laboratory device 1000 according to some aspects. In the example shown in FIG. 10, the structure includes a pipette holder 1002 and moveable component 1010 (e.g., as shown in FIGS. 4 and 5). In some examples, the pipette holder 1002 may be fixedly attached to the portable laboratory device 1000. In other examples, the pipette holder 1002 may be removably attached to the portable laboratory device 1000. The pipette holder 1002 includes a hole 1006 on a top surface within which a pipette 1006 may be inserted. The pipette holder 1002 is configured to align the pipette 1006 with a hole 1004 of the moveable component 1010 of the structure of the sample head and is utilized to ensure repeatability of the position of the pipette 1006 with respect to the hole 1008. In some examples, a cover slip may be inserted into the moveable component 1010 to receive the sample (and an optional additional cover slip may be inserted above the sample to contain the sample), as shown in FIGS. 4-6.

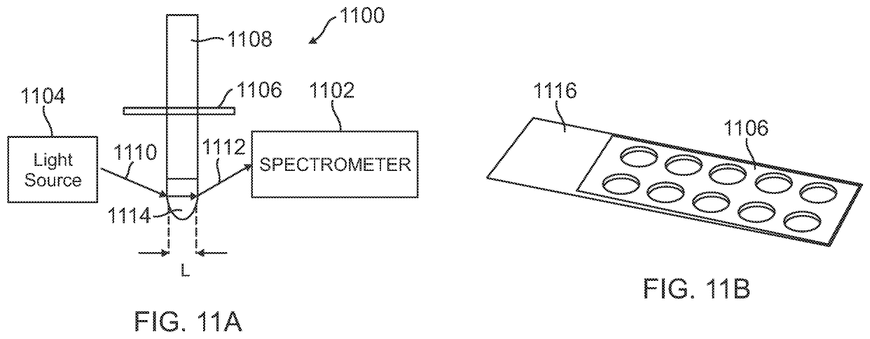

FIG. 11A is a diagram illustrating another example of a portable laboratory device 1100 according to some aspects. In the example shown in FIG. 11A, a spectrum of the sample in a media 1114 under test may be measured in transmission mode. The media containing the sample 1114 may be contained within a vial (e.g., tube) 1108 and inserted into a vial holder 1106 on the portable laboratory device 1100. In this example, the vial holder 1106 may correspond to the structure of the sample head.

In this example, the portable laboratory device 1100 includes a spectrometer 1102 and a light source 1104 arranged such that refraction of incident light 1110 from the light source 1104 through the media 1114 is oriented with respect to the radiation angle of the incident light 1110 and collection angle of the spectrometer 1102 to direct the refracted light as input light 1112 into the spectrometer 1102. The optical path length L is controlled by the precise control of the tube height with respect to the optical axis of the light source 1104 and spectrometer 1102.

In some examples, as shown in FIG. 11B, the vial holder 1106 may include a well plate within which multiple vials (tubes) 1108 may be inserted. In this example, a motorized stage 1116 may be used to automate measurement of a batch of samples. In some examples, one or more of the vials 1108 may include control samples used to control and verify the accuracy of the analysis results. In addition, leaving the vial 1108 in a vertical direction for a period of time can lead to concentration of the analyte at the bottom of the vial 1108. This can result in pre-concentration of the sample and improve the sensitivity of the spectrum.

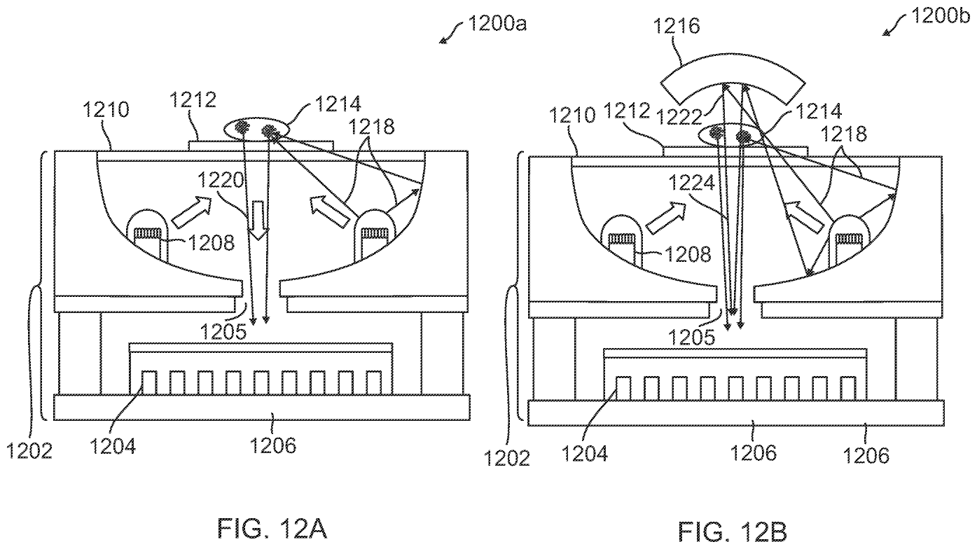

FIGS. 12A and 12B are diagrams illustrating examples of portable laboratory devices 1200a and 1200b operating in reflection mode and trans-reflection mode according to some aspects. Each of the portable laboratory devices 1200a and 1200b includes an optical measurement device 1202. The optical measurement device 1202 includes a spectrometer 1204 attached to an electronic board 1206, such as a PCB, a plurality of light sources 1208, and an optical window 1210. A cover slip 1212 is shown on the optical window 1210 and a sample 1214 under test is included on the cover slip 1212. In some examples, the cover slip 1212 may be inserted into a structure of a sample head, as shown in FIGS. 3-10. In other examples, the structure of the sample head may include the cover slip 1212. In some examples, the light sources 1208 may include laser light sources, which can enable measurements of Raman spectra of the sample 1214.

In the example shown in FIG. 12A, the portable laboratory device 1200a may operate in a diffuse reflection mode. In the diffuse reflection mode, incident light 1218 from the light source(s) 1208 is directed through the optical window 1210 and cover slip 1212 to the sample 1214. Light reflected from the sample 1214 may then be directed as input light 1220 through an optical aperture 1205 into the spectrometer 1204.

In the example shown in FIG. 12B, the portable laboratory device 1200b may operate in a diffuse trans-reflection or specular trans-reflection mode. As in FIG. 12A, incident light 1218 from the light source(s) 1208 is directed through the optical window 1210 and cover slip 1212 to the sample 1214, where the light is reflected. In addition, in the trans-reflection mode, the portable laboratory device 1200b further includes a reflector 1216 configured to receive transmitted light 1222 transmitted through the sample 1214 and to reflect that light back through the sample 1214. The light originally reflected from the sample 1214 and the additional light transmitted through the sample 1214 after reflection from the reflector 1216 can then be directed as input light 1224 through the optical aperture 1205 to the spectrometer 1204.

In some examples, the reflector 1216 may be configured as a reflecting material on a bottom surface of a cover. In some examples, the reflector 1216 may include a diffuse reflector material, such as a polytetrafluoroethylene (PTFE) sheet. The PTFE sheet can be mounted on a flat or curved surface (e.g., on the bottom of the cover). In some examples, the reflector 1216 may include a reference material used for self-calibration of the portable laboratory device 1200b.

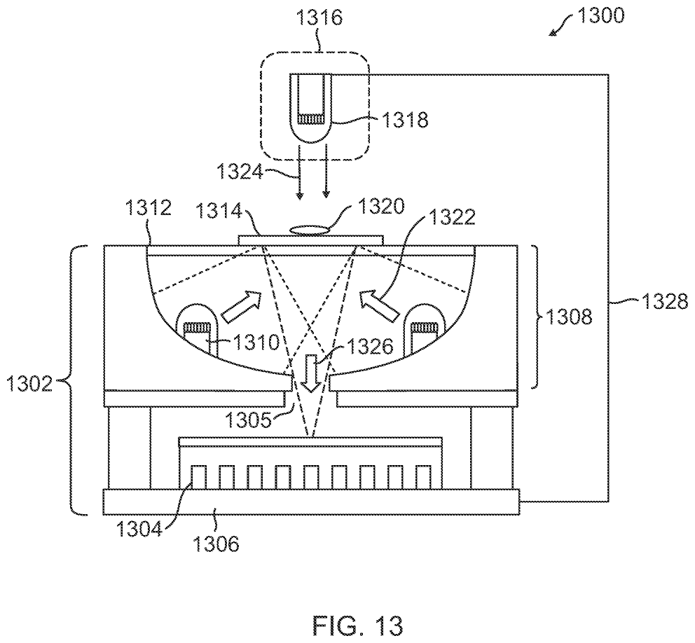

FIG. 13 is a diagram illustrating an example of a portable laboratory device 1300 operating in a transmission mode according to some aspects. The portable laboratory device 1300 may further operate in a reflection mode at the same time (e.g., a trans-reflection mode) or sequentially. The portable laboratory device 1300 includes an optical measurement device 1302. The optical measurement device 1302 includes a spectrometer 1304 attached to an electronic board 1306, such as a PCB, a source head 1308 including a plurality of reflection mode light sources 1310, and an optical window 1312. A cover slip 1314 is shown on the optical window 1312 and a sample 1320 under test is included on the cover slip 1314. In some examples, the cover slip 1312 may be inserted into a structure of a sample head, as shown in FIGS. 3-10. In other examples, the structure of the sample head may include the cover slip 1312.

In the example shown in FIG. 13, the optical measurement device 1302 further includes one or more transmission mode light source(s) 1318 (one of which is shown for convenience). In some examples, the transmission mode light source 1318 may be included within a cover 1316 of the portable laboratory device 1300. The transmission mode light source 1318 may be coupled to the electronic board 1304 of the optical measurement device 1302 via cable 1328 (or via a wireless connection) to control switching the transmission mode light source 1318 on and off. The transmission mode light source 1318 may be aligned above the source head 1308 and the sample 1320 (e.g., droplet). In some examples, the transmission mode light source 1318 may further include a lens (not shown). In some examples, the light sources 1310 and 1318 may include laser light sources, which can enable measurements of Raman spectra of the sample 1320.

In transmission mode, transmission mode incident light 1324 from the transmission mode light source 1318 is directed through the sample 1314 and refracted to produce input light 1326 that is directed through an optical aperture 1305 to the spectrometer 1304. In addition, as described above, in reflection mode, reflection mode incident light 1322 from the reflection mode light source(s) 1310 is directed through the optical window 1312 and cover slip 1314 to the sample 1320. Light reflected from the sample 1320 may then be directed as the input light 1326 through the optical aperture 1305 into the spectrometer 1304. In trans-reflection mode, both the transmission mode light source 1318 and the reflection mode light sources 1310 may direct incident light 1324 and 1322 to the sample 1314 to produce a combination of reflected and refracted light that is then directed as the input light 1326 to the spectrometer 1304.

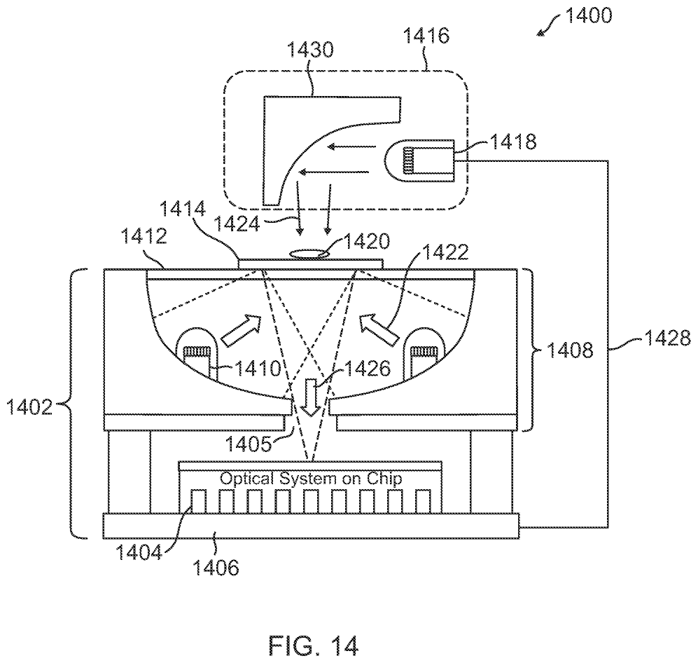

FIG. 14 is a diagram illustrating another example of a portable laboratory device 1400 operating in a transmission mode according to some aspects. The portable laboratory device 1400 may further operate in a reflection mode at the same time (e.g., a trans-reflection mode) or sequentially. The portable laboratory device 1400 includes an optical measurement device 1402. The optical measurement device 1402 includes a spectrometer 1404 attached to an electronic board 1406, such as a PCB, a source head 1408 including a plurality of reflection mode light sources 1410, and an optical window 1412. A cover slip 1414 is shown on the optical window 1412 and a sample 1420 under test is included on the cover slip 1414. In some examples, the cover slip 1414 may be inserted into a structure of a sample head, as shown in FIGS. 3-10. In other examples, the structure of the sample head may include the cover slip 1414.

In the example shown in FIG. 14, the optical measurement device 1402 further includes one or more transmission mode light source(s) 1418 (one of which is shown for convenience) and a reflector 1430 (or lens). In some examples, the transmission mode light source 1418 and reflector 1430 may be included within a cover 1416 of the portable laboratory device 1400. The transmission mode light source 1418 may be coupled to the electronic board 1404 of the optical measurement device 1402 via cable 1428 (or via a wireless connection) to control switching the transmission mode light source 1418 on and off. The transmission mode light source 1418 may be aligned above the source head 1408 and the sample 1420 (e.g., droplet). In some examples, the transmission mode light source 1418 may further include a lens (not shown). In some examples, the light sources 1410 and 1418 may include laser light sources, which can enable measurements of Raman spectra of the sample 1420.

In transmission mode, transmission mode incident light 1424 from the transmission mode light source 1418 is directed through the sample 1414 and refracted to produce input light 1426 that is directed through an optical aperture 1405 to the spectrometer 1404. In the example shown in FIG. 14, the reflector 1430 (or lens) can facilitate coupling of the transmission mode incident light 1424 through the sample 1420 to the spectrometer 1402. In addition, as described above, in reflection mode, reflection mode incident light 1422 from the reflection mode light source(s) 1410 is directed through the optical window 1412 and cover slip 1414 to the sample 1420. Light reflected from the sample 1420 may then be directed as the input light 1426 through the optical aperture 1405 into the spectrometer 1404. In trans-reflection mode, both the transmission mode light source 1418 and the reflection mode light sources 1410 may direct incident light 1424 and 1422 to the sample 1414 to produce a combination of reflected and refracted light that is then directed as the input light 1426 to the spectrometer 1404.

In some examples with biological samples, the amount of sample is small, and as such, the optical path length of the interaction between the light and the analyte in the sample may be short. To improve the detection of the virus/chemical contents within the sample, the absorbance of corresponding spectral bands may need to be amplified beyond a certain detection limit (e.g., to enable the detection of low viral load levels). This may be achieved by increasing the effective path length of the sample. According to Beer's law, absorbance A is directly proportional to path length 1. In some examples, the path length may be increased through optical path amplification, using a multi-path architecture.

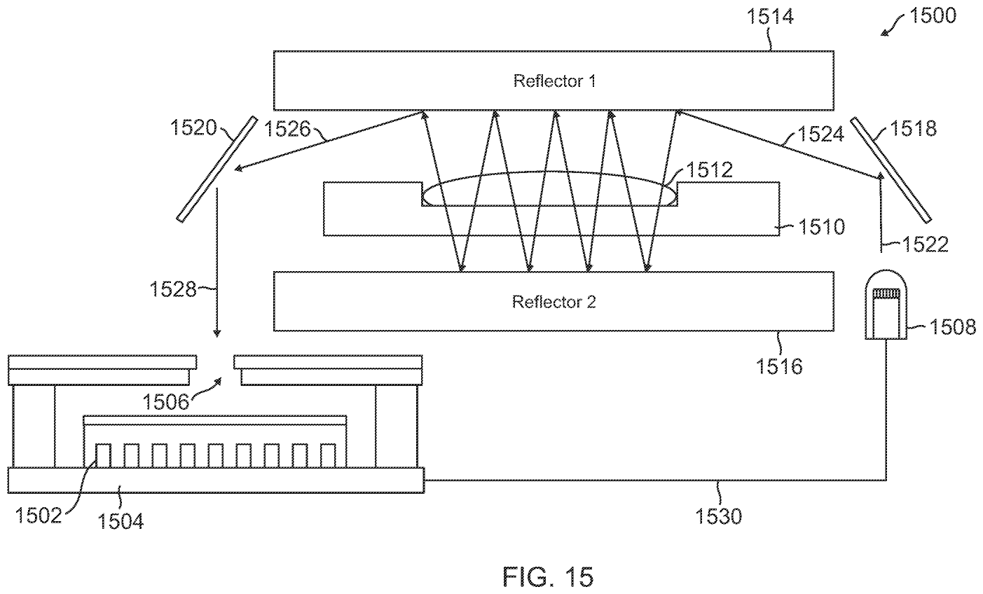

FIG. 15 is a diagram illustrating an example of a portable laboratory device 1500 including a multi-path architecture according to some aspects. The portable laboratory device 1500 includes a spectrometer 1502 attached to an electronic board 1504, such as a PCB, and a light source 1508, which may be coupled to the electronic board 1504 via cable 1530 (or via a wireless connection) to control switching the light source 1508 on and off. The spectrometer 1502, electronic board 1504, and light source 1508 may form at least part of an optical measurement device. In addition, a cover slip 1510 is shown including a sample 1512 under test.

In the example shown in FIG. 15, the cover slip 1510 is positioned between two reflectors (Reflector 1 1514 and Reflector 2 1516). As shown in FIG. 15, reflectors 1514 and 1516 may be flat reflectors. In other examples, the reflectors 1514 and 1516 may include curved reflectors. In some examples, the reflector 1514 may be included within, for example, a cover and reflector 1516 may be included on (or formed as part of) a surface of a housing containing the spectrometer 1502 or as part of the optical window of the portable laboratory device. In this example, the cover slip 1510 may be inserted into a structure of a sample head, which may be located over the reflector 1516 or moveable to be positioned over the reflector 1516. In other examples, the structure of the sample head may include the cover slip 1510, reflector 1516, and/or combination of reflectors 1514 and 1516.

The portable laboratory device 1500 may further include reflectors (e.g., mirrors) 1518 and 1520. In some examples, reflectors 1518 and 1520 may further be included within the cover. Reflector 1518 is positioned to receive incident light 1522 from the light source 1508 and to reflect the incident light towards reflector 1514 as reflected light 1524. The reflected light 1524 may then be reflected multiple times through the sample 1512 and the cover slip 1510 between the two reflectors 1514 and 1516 in one example of a multi-path architecture. The resulting multi-path reflected light 1526 can then be directed towards reflector 1520, where the multi-path reflected light 1526 is reflected as input light 1528 and directed through an optical aperture 1506 to the spectrometer 1502.

Other multi-path architectures are also possible, and the present disclosure is not limited to any particular multi-path architecture. For example, other configurations of flat reflectors, curved reflectors, and reflecting cavities may be utilized to produce the multi-path reflected light 1526. In some examples, a multi-pass cell, such as a White cell, Pfund cell, Heriot cell, circular multi-pass cell, or other suitable multi-pass cell, may be utilized to produce the multi-path reflected light 1526.

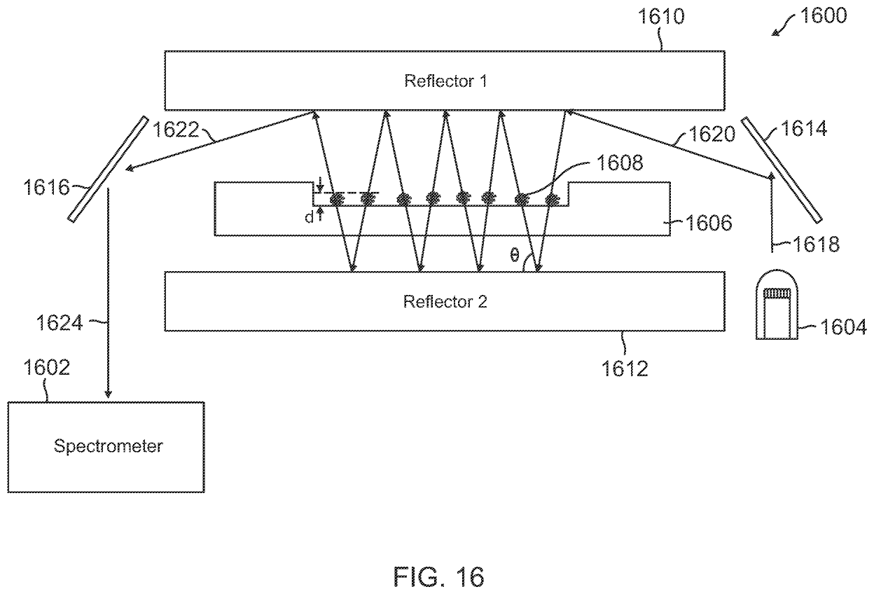

FIG. 16 is a diagram illustrating another example of a portable laboratory device 1600 including a multi-path architecture according to some aspects. As in FIG. 15, the portable laboratory device 1600 includes a spectrometer 1602, a light source 1604, and a cover slip 1606 including a sample 1608. The portable laboratory device 1600 further includes reflectors 1610 and 1612 positioned on either side of the cover slip 1606, along with reflectors (e.g., mirrors) 1614 and 1616. In this example, the cover slip 1606 may be inserted into a structure of a sample head, which may be located over the reflector 1612 or moveable to be positioned over the reflector 1612. In other examples, the structure of the sample head may include the cover slip 1606, reflector 1612 and/or combination of reflectors 1610 and 1612.

Reflector 1614 is positioned to reflect incident light 1618 from the light source 1604 and to direct the resulting reflected light 1620 towards reflector 1610. The reflected light 1620 may then be reflected multiple times through the sample 1608 and the cover slip 1606 between the two reflectors 1610 and 1612. The resulting multi-path reflected light 1622 can then be directed towards reflector 1616, where the multi-path reflected light 1622 is reflected as input light 1624 and directed towards an input of the spectrometer 1602.

In the example shown in FIG. 16, water in the media containing the sample 1608 has been removed, thus leaving the sample analyte 1608 on the cover slip 1606. Water is highly absorbing in the infrared region. In addition, the spectrum of water is highly dependent on the environmental conditions, such as the temperature. Therefore, in some examples, the water in the sample may be removed. As shown in FIG. 16, the effective thickness of the sample analyte 1608 is denoted d, and the light (e.g., reflected light 1620) reflected through the sample analyte 1608 is reflected at an angle θ. Therefore, the interaction length per pass is given by L=d/sin θ. The total path length is given by NL where N is the number of passes.

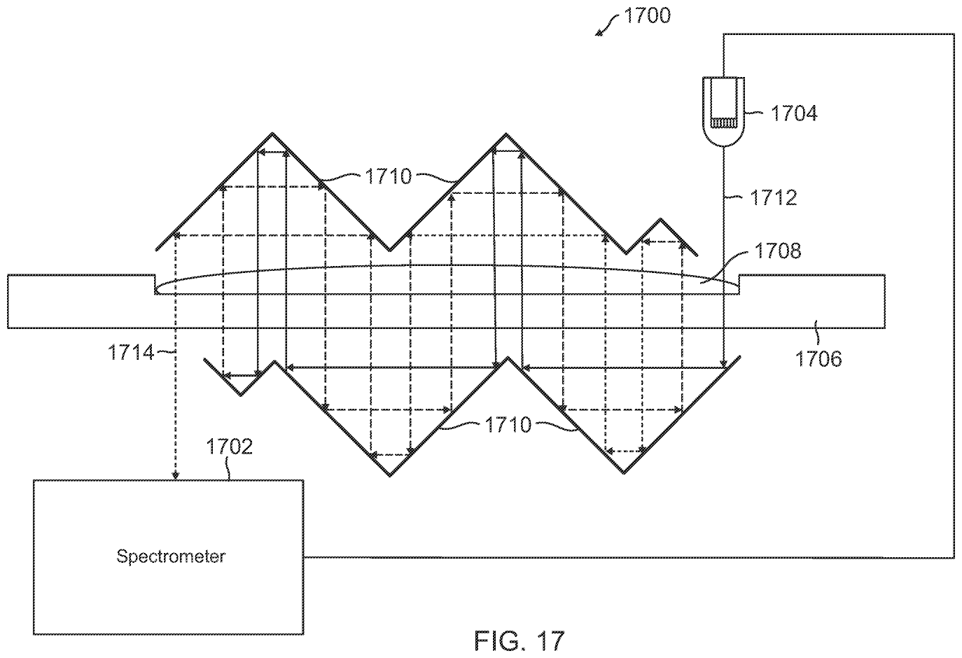

FIG. 17 is a diagram illustrating another example of a portable laboratory device 1700 including a multi-path architecture according to some aspects. As in the examples shown in FIGS. 15 and 16, the portable laboratory device 1700 includes a spectrometer 1702, a light source 1704, and a cover slip 1706 including a sample 1708. In the example shown in FIG. 17, the portable laboratory device 1700 further includes multiple corner (retro) reflectors 1710 for optical path length amplification. For example, incident light 1712 from the light source 1704 can be directed towards one of the corner reflectors 1710 for multiple reflections of the incident light through the cover slip 1706 and the sample 1708. Multi-reflected light output from the corner reflectors 1710 may be directed as input light into the spectrometer 1702. In this example, the cover slip 1706 may be inserted into a sample head, which may be located over the bottom set of corner reflectors 1710 or moveable to be positioned over the bottom set of corner reflectors 1710. In other examples, the structure of the sample head may include the cover slip 1706, bottom set of corner reflectors 1710, and/or combination of the bottom and top set of corner reflectors 1710.

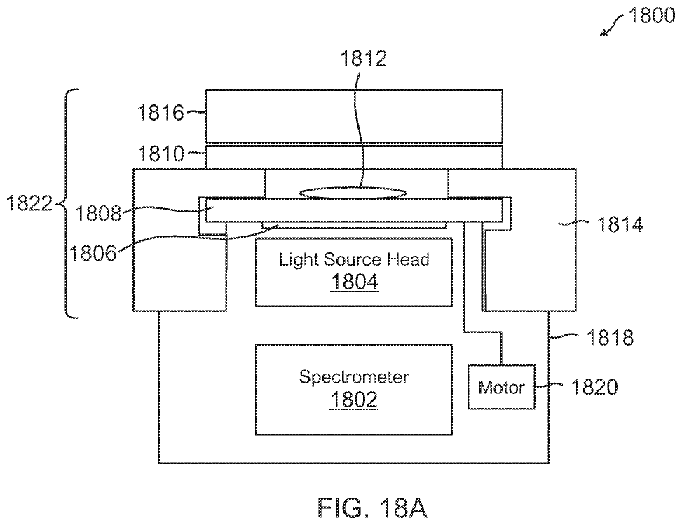

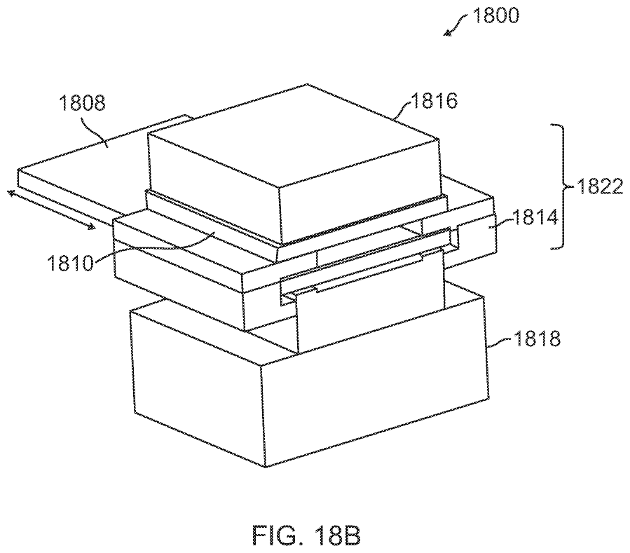

FIGS. 18A and 18B are diagrams illustrating an example of a portable laboratory device 1800 including a structure of a sample head 1822, where the structure corresponds to a guiding spacer 1814 according to some aspects. FIG. 18A is a back view of the portable laboratory device 1800, while FIG. 18B is a side view of the portable laboratory device 1800. The portable laboratory device 1800 includes a spectrometer 1802, a light source head 1804, and an optical window 1806, which may collectively form an optical measurement device. The light source head 1804 may include, for example, one or more light sources, as shown and described in FIGS. 3, 6, and 11-17.

The portable laboratory device 1800 further includes cover slips (e.g., glass slides) 1808 and 1810 that are inserted into the sample head 1822. For example, the sample head 1822 may include an opening configured to receive the glass slides 1808 and 1810. A first glass slide 1808 is configured to receive a sample 1812. A second glass slide 1810 may be utilized to precisely control the interaction path length between the light and the sample 1812. In addition, the second glass slide 1810 may prevent the evaporation of the sample 1812 during the analysis. A cover 1816 of the sample head 1822 may be included on top of the second glass slide 1810. In some examples, the cover 1816 may include a material slab, such as a ceramic or PTFE sheet, a reflectance spectralon, or a reference material.

The guiding spacer 1814 forming the structure of the sample head 1822 is attached to a housing 1818 of the portable laboratory device 1800. In the example shown in FIG. 18, the guiding spacer 1814 is attached to the housing 1818 near the light source head 1814. The housing 1818 may include the spectrometer 1802, the light source head 1804, a motor 1820, in addition to other circuits and/or devices, such as a data transfer device, spectrum analyzer, and/or user interface.

The guiding spacer 1814 is configured to facilitate insertion and removal of the first glass slide 1808 into the sample head 1822. In addition, the guiding spacer 1814 operates as a guide for lateral alignment of the first glass slide 1808 and may serve as a spacer between the first and second glass slides 1808 and 1810. In some examples, the spacing between the glass slides 1808 and 1810 is suitable for the droplet height of the sample 1812. The guiding spacer 1814 may further operate as a holder for the second glass slide 1810 and the material slab 1816. In some examples, the motor 1820 may be configured to translate the first glass slide 1808. In some examples, the motor 1820 may translate the first glass slide 1808 in synchronization with switching on the light source(s) in the light source head 1804 for acquisition of a measurement (e.g., a spectrum) of the sample 1812.

Once the sample 1812 collected from the subject is transferred to a media, abundancy of the media containing the sample 1812 can be available. In some examples, measuring a large quantity of the applied sample 1812 at once can hinder the signal due to the absorption of other interfering elements such as water absorption. In this case, it is important to limit the applied sample volume to a certain amount and do multiple measurements. For example, the applied samples can be distributed on the first glass slide 1808, which may be translated (e.g., by the motor 1820) using the guiding spacer 1814.

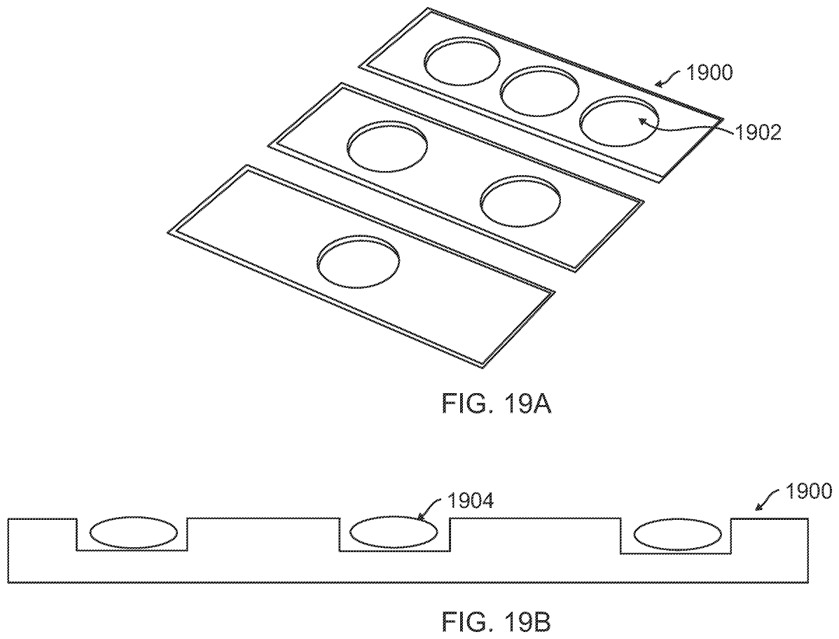

FIGS. 19A and 19B are diagrams illustrating examples of a cover slip (e.g., glass slide) 1900 according to some aspects. In the example shown in FIGS. 19A and 19B, the glass slide 1900 including a plurality of wells 1902. Each of the wells 1902 may be configured to receive a respective sample 1904.

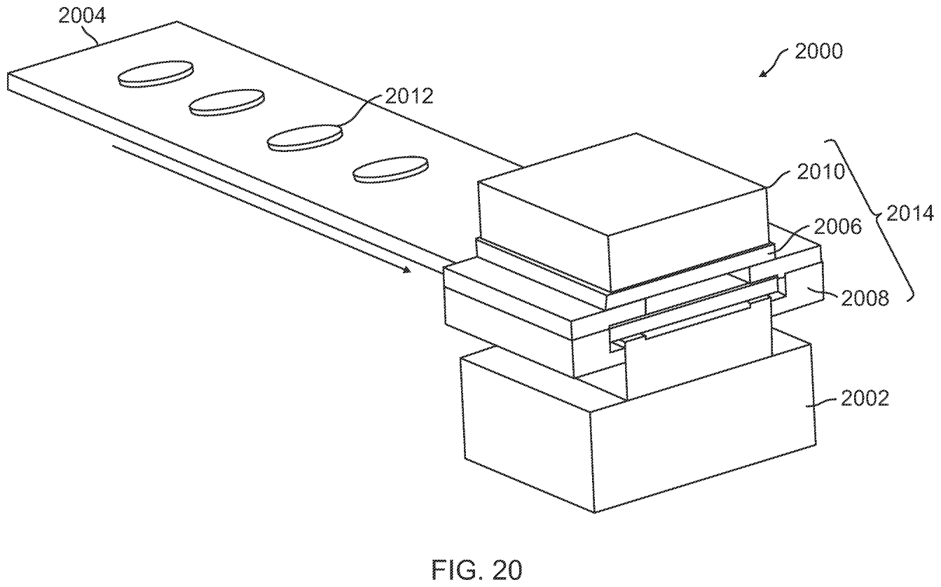

FIG. 20 is a diagram illustrating an example of a portable laboratory device 2000 for performing measurements of multiple samples according to some aspects. The portable laboratory device 2000 includes a housing 2002, which may include, for example, a spectrometer, a light source head, and a motor, as shown in FIG. 18, in addition to other circuits and/or devices, such as a data transfer device, spectrum analyzer, user interface, etc. The portable laboratory device 2000 further includes a sample head 2014, which may include, for example, an opening configured to receive a first glass slide 2004 and a second glass slide 2006, a guiding spacer 2008, and a cover 2010 (e.g., a material slab).

The guiding spacer 2008 may be configured to facilitate insertion of the first glass slide 2004 into the sample head 2014 and further to facilitate translation of the first glass slide 2004. In the example shown in FIG. 20, the first glass slide 2004 includes a plurality of wells (cavities), each configured to receive a respective sample 2012. In an exemplary operation of the portable laboratory device 2000, the first glass slide 2004 may be translated to acquire a respective spectrum of each of the samples 2012.

FIG. 21 is a diagram illustrating an example of a portable laboratory device 2100 for performing a measurement of a sample according to some aspects. The portable laboratory device 2100 includes a housing 2102, which may include, for example, a spectrometer, a light source head, and a motor, as shown in FIG. 18, in addition to other circuits and/or devices, such as a data transfer device, spectrum analyzer, user interface, etc. The portable laboratory device 2100 further includes a sample head 2114, which may include, for example, an opening configured to receive a first glass slide 2104 and a second glass slide 2106, a guiding spacer 2108, and a cover 2110 (e.g., a material slab).

The guiding spacer 2008 may be configured to facilitate insertion of the first glass slide 2104 into the sample head 2114 and further to facilitate translation of the first glass slide 2104. In some examples, a sample 2112 may be placed on the first glass slide 2104 in an elongated manner such that the sample 2112 covers a large portion of the first glass slide 2104. In this example, the entire sample 2112 may be scanned and the corresponding spectrum acquired continuously by translating the first glass slide 2104 (e.g., using the motor 1820 shown in FIG. 18) while the light source(s) are on.

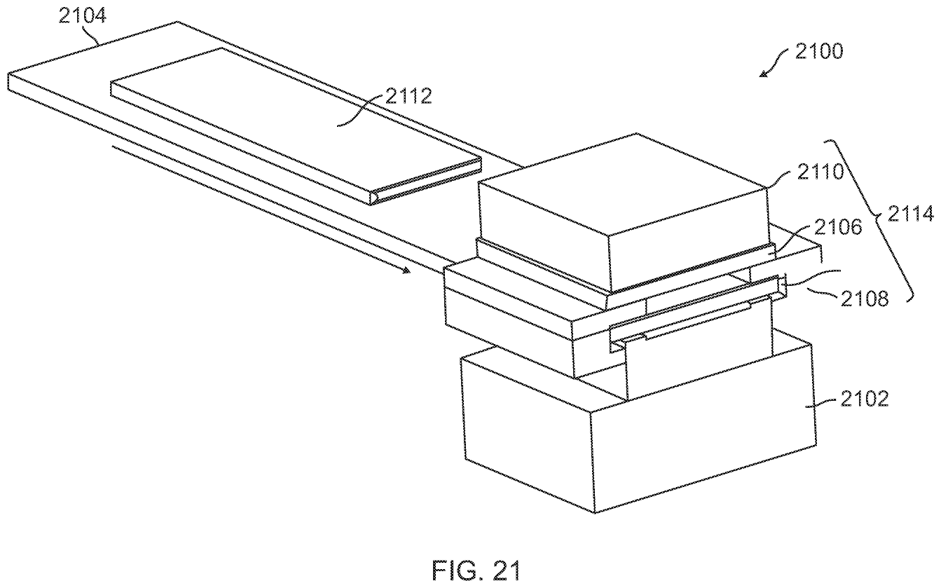

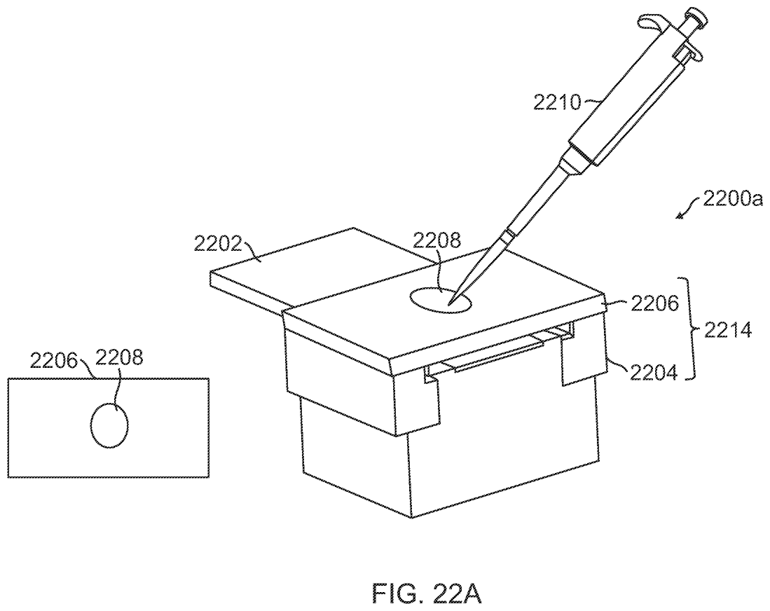

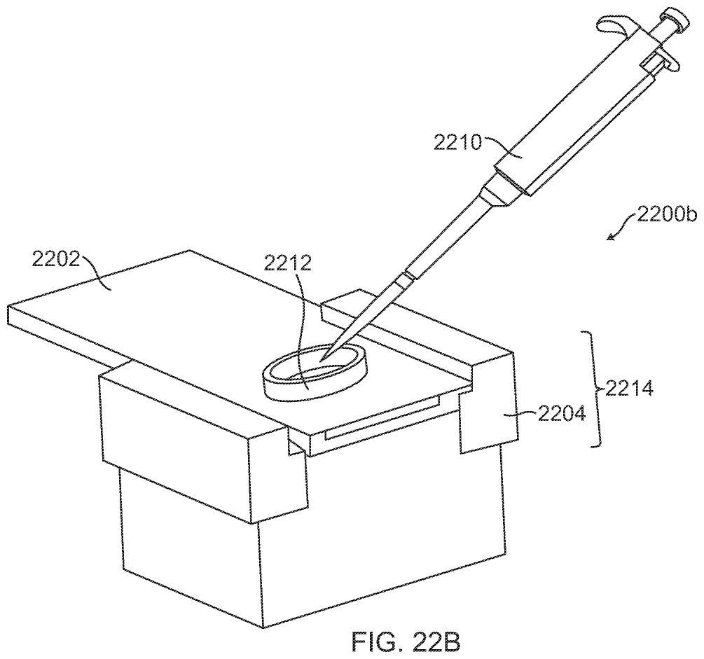

FIGS. 22A and 22B are diagrams illustrating other examples of a portable laboratory device 2200a and 2200b including a structure of a sample head 2214, where the structure corresponds to a guiding spacer 2204 for guiding insertion and removal of a glass slide 2202 into the sample head 2214 according to some aspects. In the example shown in FIG. 22A, the guiding spacer 2204 includes a top portion 2206 having a hole 2208 configured to facilitate application of a sample on the glass slide 2202. For example, a pipette 2210 may be utilized to inject a droplet of the sample on the glass slide 2202 through the hole 2208.

In the example shown in FIG. 22B, the glass slide 2202 includes a frame 2212 in which the sample may be injected (e.g., via the pipette 2210). In this example, the guiding spacer 2204 is open at the top (e.g., excludes a top portion) to facilitate injection of the sample using the frame 2212.

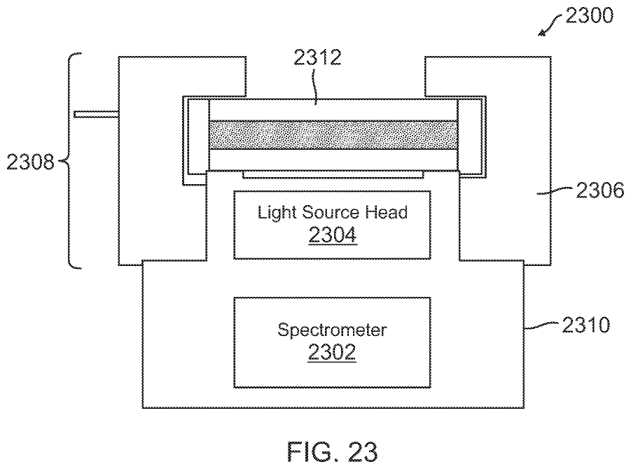

FIG. 23 is a diagram illustrating another example of a portable laboratory device 2300 including a structure of a sample head 2308, where the structure corresponds to a guiding spacer 2306 according to some aspects. The portable laboratory device 2300 includes a housing 2310, which may include, for example, a spectrometer 2302 and a light source head 2304, in addition to other circuits and/or devices, such as a data transfer device, spectrum analyzer, user interface, etc. The portable laboratory device 2300 further includes the sample head 2308, which may include an opening configured to receive a cuvette or a vial (shown as cuvette 2312) within which a sample may be injected, and the guiding spacer 2306.

The guiding spacer 2306 may be configured to facilitate insertion and removal of the cuvette 2312 into the sample head 2308. The spacing provided by the guiding spacer 2306 is suitable to account for the cuvette wall thickness and the desired optical path length for the interaction between the light and the sample inside the cuvette 2312. In some examples, the light source head 2304 may be configured to illuminate the cuvette 2312 from the bottom while the portable laboratory device 2300 is operating in a diffuse reflection mode. In other examples, the portable laboratory device 2300 may include one or more transmission mode light sources that may be utilized to illuminate the cuvette 2312 from the top while the portable laboratory device 2300 is operating in a transmission mode and/or trans-reflection mode.

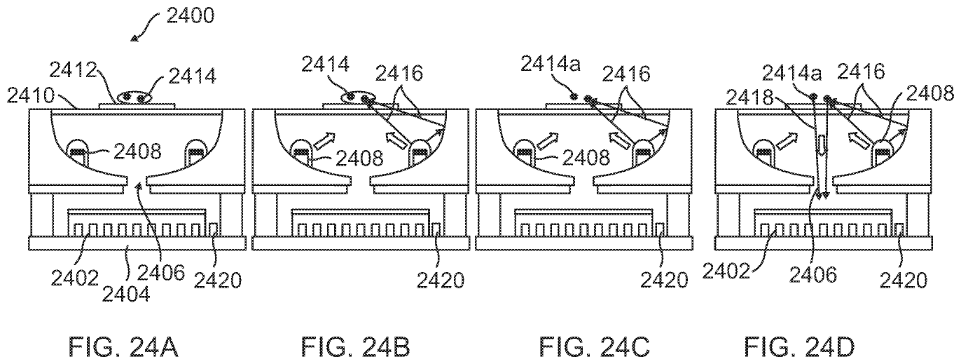

FIGS. 24A-24D illustrate an example of a portable laboratory device 2400 configured to heat a sample according to some aspects. The portable laboratory device 2400 includes a spectrometer 2402 attached to an electronic board 2404, such as a PCB, a plurality of light sources 2408, and an optical window 2410. The spectrometer 2402, electronic board 2404, light sources 2408, and optical window 2410 may form an optical measurement device. The optical measurement device may further include a switch 2420 coupled to the light sources 2408 and other suitable circuits and/or devices, such as a data transfer device, spectrum analyzer, and user interface. A cover slip 2412 is shown on the optical window 2410 and a sample 2414 under test is included on the cover slip 2412. In some examples, the cover slip 2412 may be inserted into a structure of a sample head, as shown in FIGS. 3-10. In other examples, the structure of the sample head may include the cover slip 2412. In some examples, the light sources 2408 may include laser light sources, which can enable measurements of Raman spectra of the sample 2414.

In the example shown in FIG. 24A, the sample 2414 may be placed on the cover slip 2412. As shown in FIG. 24B, the switch 2420 may be configured to switch on the light sources 2408 to direct incident light 2416 through the optical window 2410 and cover slip 2412 towards the sample 2414. In this example, the incident light 2416 may be utilized to heat and dry the sample 2414 to produce a dried sample 2414a, as shown in FIG. 24C. Drying of the sample 2414 may occur as a result of the O—H groups of the water content of the sample 2414 absorbing a majority of the incident light 2416.

The temperature of the sample 2414 may be controlled by the on-off times of the light sources 2408 produced by the switch 2420. For example, off-times can lead to sample cooling, thus delaying the heating process of the sample 2414 or cycling the temperature of the sample 2414. The temperature of the sample 2414 may further be controlled by the number of light bulbs 2408 turned on the by switch 2420 and/or the driving voltage of the light bulbs 2408 provided by the switch 2420. For example, more than one light source 2408 may be used to dry the sample 2414 to expedite the drying process. In some examples, additional drying mechanisms may be utilized to accelerate drying of the sample 2414. For example, vacuum suction or air flow may be applied in parallel to heating the sample 2414 by the light sources 2408.

As shown in FIG. 24D, the incident light 2416 from the light source(s) 2408 that is directed towards the dried sample 2414a can further be used to measure the spectrum of the dried sample 2414a. In this example, light reflected from the sample 2414 may then be directed as input light 2418 through an optical aperture 2406 into the spectrometer 2402. In some examples, the sample 2414 may be monitored by continuously measuring the spectrum of the input light 2418 collected from the sample 2414. In this example, multiple light sources 2408 may be used to not only expedite drying of the sample 2414, but also to increase the optical signal level reaching the detector of the spectrometer 2402, thus improving the sensitivity of the portable laboratory device 2400. Once the spectrum of the sample 2414 is stabilized, thus indicating that the sample has dried, the spectrum for the dried sample 2414a may be obtained.

In the example shown in FIGS. 24A-24D, drying of the sample 2414 is achieved using the same light sources 2408 used to measure the spectrum of the sample 2414. In other examples, drying of the sample 2414 may be achieved by the reflection mode light sources 2408 shown in FIGS. 24A-24D, while the spectrum is obtained using a transmission mode light source (e.g., as shown in FIGS. 13 and 14). In this example, additional heating may be performed by the transmission mode light source.

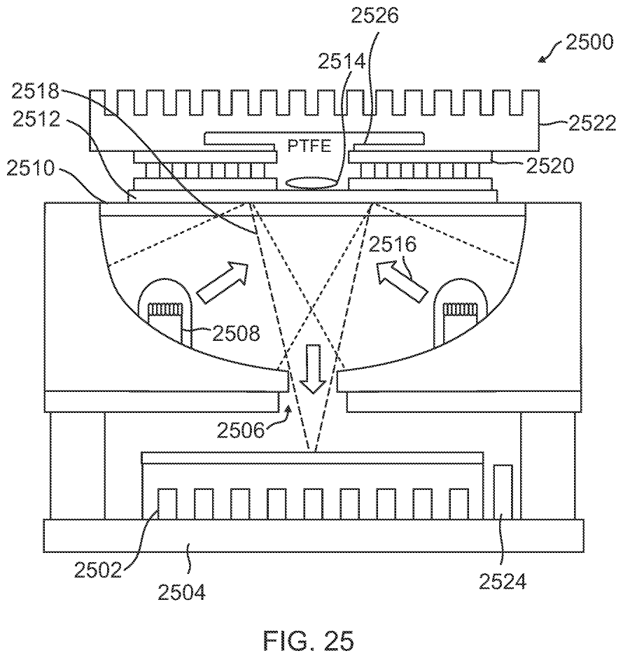

FIG. 25 is a diagram illustrating another example of a portable laboratory device 2500 configured to heat a sample according to some aspects. The portable laboratory device 2500 includes a spectrometer 2502 attached to an electronic board 2504, such as a PCB, a plurality of light sources 2508, and an optical window 2510. The spectrometer 2502, electronic board 2504, light sources 2508, and optical window 2510 may form an optical measurement device. The optical measurement device may further include a switch 2524 coupled to the light sources 2508 and other suitable circuits and/or devices, such as a data transfer device, spectrum analyzer, and user interface. A cover slip 2512 is shown on the optical window 2510 and a sample 2514 under test is included on the cover slip 2512. In some examples, the cover slip 2512 may be inserted into a structure of a sample head, as shown in FIGS. 3-10. In other examples, the structure of the sample head may include the cover slip 2512. In some examples, the light sources 2508 may include laser light sources, which can enable measurements of Raman spectra of the sample 2514.

The switch 2524 may be configured to switch on the light sources 2508 to direct incident light 2516 through the optical window 2510 and cover slip 2512 to heat and dry the sample 2514. In addition, the incident light 2516 can further be used to measure the spectrum of the dried sample. In this example, light reflected from the sample 2514 may then be directed as input light 2518 through an optical aperture 2506 into the spectrometer 2502.

In the example shown in FIG. 25, a diffuse reflector material 2526, such as PTFE, may be positioned above the sample 2514 to reflect the incident light 2516 back through the sample 2514 opposite the optical window 2510 to further accelerate heating of the sample 2514 and/or facilitate operation in a trans-reflectance mode. The sample temperature may further be controlled by a thermo-electric cooler (TEC) Peltier element 2520. A bottom surface of the Peltier element 2520 may be, for example, attached to the cover slip 2510 to heat/cool the sample 2514 electrically. In addition, a heat sink 2522 may be attached to an upper surface of the Peltier element 2520.

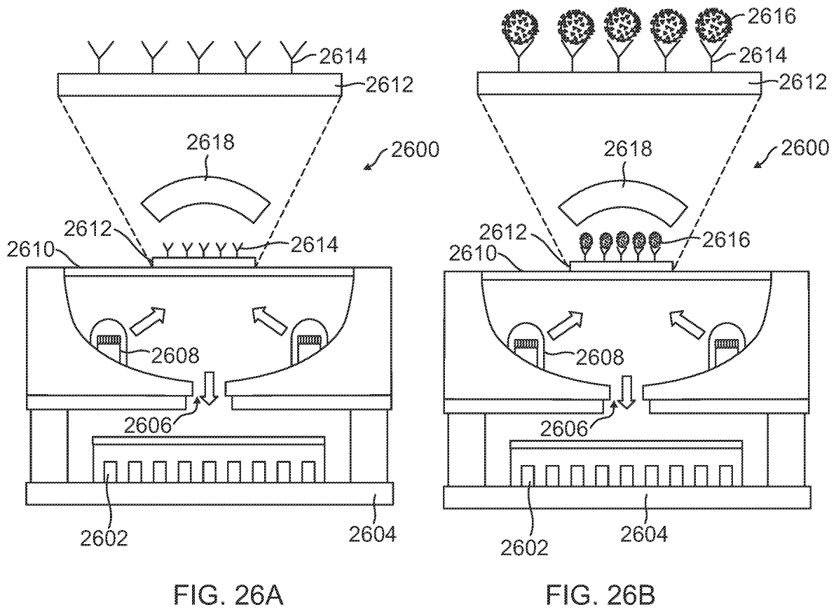

FIGS. 26A and 26B are diagrams illustrating an example of a portable laboratory device 2600 including functionalized cover slips according to some aspects. The portable laboratory device 2600 includes a spectrometer 2602 having an optical aperture 2606 and attached to an electronic board 2604, such as a PCB, a plurality of light sources 2608, and an optical window 2610. The spectrometer 2602, electronic board 2604, light sources 2608, and optical window 2610 may form an optical measurement device. The optical measurement device may further include other suitable circuits and/or devices, such as a data transfer device, spectrum analyzer, and user interface. A cover slip 2612 may be positioned on the optical window 2610. In some examples, the cover slip 2612 may be inserted into a structure of a sample head, as shown in FIGS. 3-10. In other examples, the structure of the sample head may include the cover slip 2612. In some examples, the light sources 2608 may include laser light sources, which can enable measurements of Raman spectra of the sample 2614. The portable laboratory device 2600 may further include a reflector 2618 for operation in a trans-reflectance mode.

In the example shown in FIG. 26A, the cover slip 2612 is a functionalized cover slip for a particular biological sample to be detected. The functionalization indicates the creation of receptors 2614 on the surface of the cover slip 2612. As shown in FIG. 26A, the functionalized cover slip 2612 with receptors 2614 may initially be measured using the spectrometer 2602 without applying the sample. The measured spectrum can be used as a background spectrum. Then, as shown in FIG. 26B, a sample 2616 is applied to the cover slip 2612. In some examples, the sample 2616 on the cover slip 2612 may optionally be washed. As can be seen in FIG. 26B, the analyte in the sample 2616 binds to the receptors, which causes a change in the absorption spectrum of the cover slip 2612. A new spectrum can then be measured using the spectrometer 2602, as shown in FIG. 26B. The new spectrum and the background spectrum are used to calculate the change in the spectrum, and this change may be input to the AI engine (e.g., spectrum analyzer).

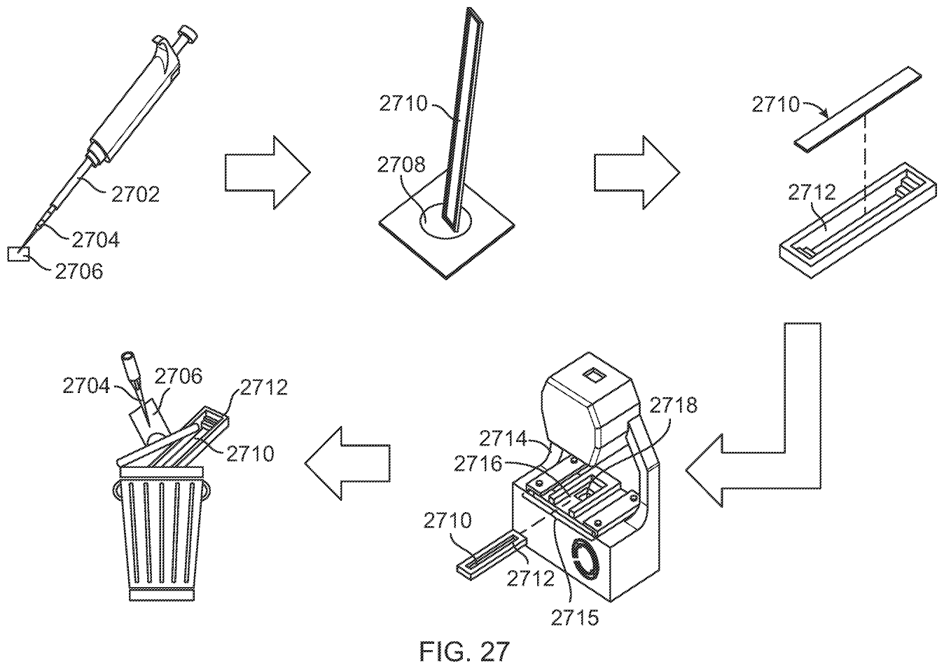

FIG. 27 is a diagram illustrating an example measurement operation using a cuvette according to some aspects. In the example shown in FIG. 27, a pipette 2702 includes a pipette tip 2704 configured to apply a sample 2708 (e.g., within a viral transport media (VTM)) to a cover slip 2706 (e.g., a glass slide). A cuvette 2710 may then be placed on the cover slip 2706 to allow the VTM sample 2708 to be inserted into the cuvette 2710 by capillary force. For example, the cuvette 2710 may be open on two sides and due to surface tension in the VTM sample 2708, a capillary action within the cuvette 2710 may cause the VTM sample 2708 to be drawn up into the cuvette 2710 from the cover slip 2706. The cuvette 2710 may then be inserted into a cuvette holder 2712. In some examples, instead of applying the sample 2708 to the cover slip 2706, the pipette 2702 may insert the sample directly into the cuvette holder 2712. For example, the cuvette holder 2712 may include a reservoir (not shown) configured to receive the sample 2708. Once the cuvette 2710 is inserted into the cuvette holder 2712, the sample 2708 may then be drawn into the cuvette 2710 by surface tension force.

The cuvette holder 2712 containing the cuvette 2710 may then be placed within a structure 2716 of a sample head 2715 on a portable laboratory device 2714. The structure 2716 of the sample head 2715 may be configured to align the cuvette 2710 with an optical window 2718 on the portable laboratory device 2714 to facilitate illumination of the sample 2708 in order to obtain a spectrum of the sample 2708. In the example shown in FIG. 27, the portable laboratory device 2714 may operate in a transmission mode by illuminating the sample 2702 from above. After performing the measurement of the sample 2708, the cuvette 2710, cuvette holder 2712, pipette tip 2704, and cover slip 2706 may be disposed of.

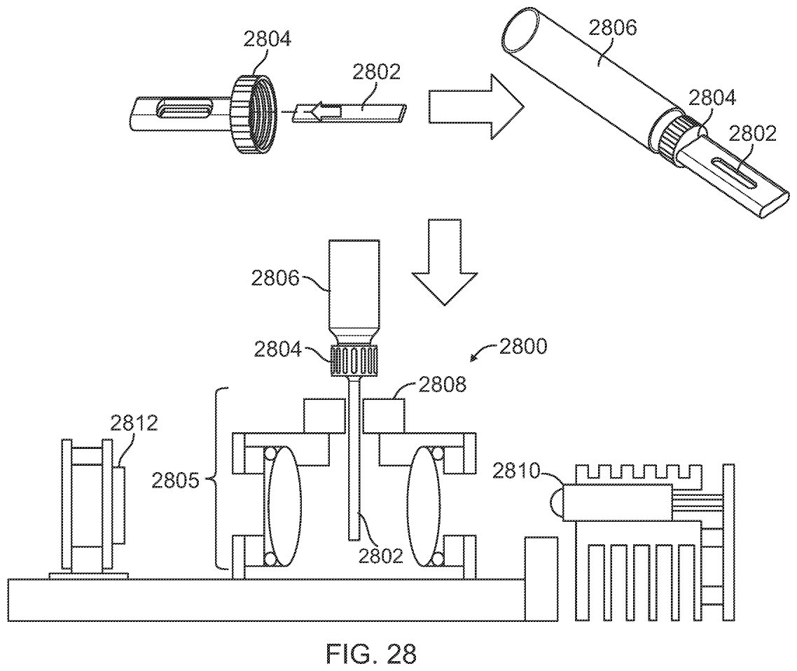

FIG. 28 is a diagram illustrating another example measurement operation using a cuvette according to some aspects. In the example shown in FIG. 28, a cuvette 2802 may be inserted into an adapter 2804. The adapter 2804 containing the cuvette 2802 may then be attached to a vial 2806 containing a sample (e.g., VTM sample). The adapter 2804 may include an opening providing an interface between the cuvette 2802 and the vial 2806, thus facilitating the insertion of the VTM sample in the vial 2806 into the cuvette 2802 by capillary force. For example, by turning the vial 2806 upside down, the VTM sample may move to the cuvette 2802 based on the capillary action of the cuvette 2802. The adapter 2804 may further prevent contamination of surfaces or in-room air.

The adapter 2804 containing the cuvette 2802 may then be inserted into a structure 2808 of a sample head 2805 (e.g., a cuvette holder) of a portable laboratory device 2800. In the example shown in FIG. 28, the structure 2808 of the sample head 2805 aligns the cuvette 2802 with a light source 2810 and spectrometer 2812 of the portable laboratory device 2800. The portable laboratory device 2800 in FIG. 28 is shown operating in a transmission mode to illuminate the sample from the side and to direct the refracted light from the sample as input light into the spectrometer 2812. Additional optical devices, such as lenses or mirrors, may also be included in the portable laboratory device 2800 to facilitate directing the incident light from the light source 2810 to the sample and the refracted light from the sample to the spectrometer 2812.

The following provides an overview of examples of the present disclosure.

Example 1: A portable laboratory device, comprising: a sample head configured to receive a sample and comprising a structure configured to facilitate application of the sample to the sample head; and an optical measurement device comprising: at least one light source configured to direct incident light towards the sample to produce input light; a spectrometer configured to receive the input light from the sample and to obtain a spectrum of the sample based on the input light; and a data transfer device configured to transfer the spectrum to a spectrum analyzer and to receive a result associated with the sample from the spectrum analyzer.

Example 2: The portable laboratory device of example 1, wherein the spectrometer comprises a micro-electro-mechanical systems (MEMS) interferometer and the at least one light source comprises at least one infrared light source.

Example 3: The portable laboratory device of example 1 or 2, wherein the data transfer device comprises a wireless transceiver configured to communicate with the spectrum analyzer.

Example 4: The portable laboratory device of example 1 or 2, further comprising: the spectrum analyzer, wherein the data transfer device comprises a bus configured to transfer the spectrum to the spectrum analyzer.

Example 5: The portable laboratory device of any of examples 1 through 4, wherein the spectrum analyzer comprises an artificial intelligence engine configured to produce the result from the spectrum.

Example 6: The portable laboratory device of example 5, wherein the spectrum comprises a measured absorption spectra and the artificial intelligence model is configured to detect one or more analytes from absorption signals of the measured absorption spectra in a near-infrared frequency range.

Example 7: The portable laboratory device of example 5 or 6, wherein the sample head is configured to receive a media containing the sample, and the artificial intelligence engine is configured to produce the result based on the media.

Example 8: The portable laboratory device of any of examples 5 through 7, wherein the artificial intelligence engine comprises a plurality of calibration models, each constructed for a respective media type of a plurality of media types, and further comprising: an input device configured to select a calibration model of the plurality of calibration models for a media type of the plurality of media types corresponding to the media containing the sample.

Example 9: The portable laboratory device of any of examples 1 through 8, wherein the structure of the sample head comprises a tool coupled to a housing of the portable laboratory device and configured to facilitate application of the sample to the sample head.

Example 10: The portable laboratory device of any of examples 1 through 9, wherein the structure of the sample head comprises a hole configured to align the sample with an optical window of the optical measurement device.

Example 11: The portable laboratory device of example 10, wherein the structure of the sample head further comprises a cavity configured to receive a cover slip on which the sample is placed, the cavity being positioned over the hole.

Example 12: The portable laboratory device of example 11, wherein the cover slip comprises a frame in which the sample is placed.

Example 13: The portable laboratory device of example 11 or 12, wherein the cover slip comprises a functionalized cover slip with receptors configured to bind with an analyte in the sample.

Example 14: The portable laboratory device of any of examples 10 through 13, wherein the cavity comprises a first cavity configured to receive a first cover slip and a second cavity positioned over the first cavity configured to receive a second cover slip to contain the sample between the first cover slip and the second cover slip.

Example 15: The portable laboratory device of example 14, wherein the second cavity is rotated with respect to the first cavity.

Example 16: The portable laboratory device of example 14 or 15, wherein the first cavity and the second cavity each comprise an inclination angle with respect to a plane of the optical window of the optical measurement device.

Example 17: The portable laboratory device of any of examples 10 through 16, wherein the structure of the sample head is moveable from a first position to receive the sample and a second position above the optical window of the optical measurement device.

Example 18: The portable laboratory device of any of examples 1 through 16, wherein the sample head further comprises a cover configured to be positioned over the structure of the sample head, wherein the cover comprises a top surface and a bottom surface opposite the structure.

Example 19: The portable laboratory device of example 18, wherein the bottom surface of the cover comprises a reflecting surface or a reference material.

Example 20: The portable laboratory device of example 18 or 19, wherein the cover comprises a transmission mode light source of the at least one light source configured to direct the incident light towards the sample in a transmission mode.

Example 21: The portable laboratory device of example 20, wherein the cover comprises at least one reflector configured to direct the incident light towards the sample.

Example 22: The portable laboratory device of example 20 or 21, wherein the at least one light source further comprises a plurality of light sources arranged to direct the incident light towards the sample in a reflection mode simultaneously to the transmission mode or sequentially with respect to the transmission mode.

Example 23: The portable laboratory device of any of examples 1 through 8, wherein the structure of the sample head comprises a well plate array configured to receive a plurality of samples and further comprising: a motorized stage configured to automate measurement of the plurality of samples by the optical measurement device.

Example 24: The portable laboratory device of any of examples 1 through 23, further comprising: a first reflector positioned under the sample; and a second reflector positioned over the sample opposite the first reflector, wherein the first reflector and the second reflector are configured to direct the incident light multiple times through the sample to produce the input light.

Example 25: The portable laboratory device of example 24, further comprising: a third reflector configured to receive the incident light and to direct the incident light toward the second reflector; and a fourth reflector configured to receive the input light and to direct the input light to the spectrometer.

Example 26: The portable laboratory device of example 24 or 25, wherein the first reflector and the second reflector comprise respective flat reflectors, respective curved reflectors, or respective arrays of corner reflectors.

Example 27: The portable laboratory device of example 24 or 25, further comprising: a multi-pass cell comprising the first reflector and the second reflector.

Example 28: The portable laboratory device of any of examples 1 through 8, wherein the structure of the sample head comprises a guiding spacer attached to a housing comprising the optical measurement device, wherein the guiding spacer is configured to guide insertion of the sample into the sample head.

Example 29: The portable laboratory device of example 28, wherein the guiding spacer is configured to receive a cuvette in which the sample is inserted.

Example 30: The portable laboratory device of example 28, further comprising: a first slide on which the sample is positioned; a second slide positioned on the guiding spacer above the first slide; and a material slab positioned on the second slide.

Example 31: The portable laboratory device of example 30, wherein the first slide comprises a plurality of wells, each configured to receive a respective sample of a plurality of samples including the sample.

Example 32: The portable laboratory device of example 30 or 31, wherein the guiding spacer comprises a hole configured to facilitate application of the sample on the first slide.

Example 33: The portable laboratory device of any of examples 30 through 32, further comprising a motor configured to translate the first slide to obtain the spectrum of the sample.

Example 34: The portable laboratory device of any of examples 1 through 33, further comprising: a switch coupled to the least one light source to switch on the at least one light source to dry the sample and produce a dried sample, wherein the spectrometer is configured to obtain the spectrum of the dried sample.

Example 35: The portable laboratory device of any of examples 1 through 33, further comprising: an excitation element configured to control one or more physical properties of the sample.

Example 36: The portable laboratory device of any of examples 1 through 35, further comprising: a display for displaying the result.

Example 37: The portable laboratory device of any of examples 1 through 8 or 34 through 36, wherein the structure of the sample head is configured to receive a cuvette holder containing a cuvette within which the sample is inserted.

Example 38: The portable laboratory device of any of examples 1 through 8 or 34 through 36, wherein the structure of the sample head is configured to receive an adapter containing a cuvette, the adapter being attached to a vial containing the sample that is inserted into the cuvette via capillary force.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-28 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-28 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A portable laboratory device, comprising:
a sample head configured to receive a sample and comprising a structure configured to facilitate application of the sample to the sample head; and
an optical measurement device comprising:
at least one light source configured to direct incident light towards the sample to produce input light;
a spectrometer configured to receive the input light from the sample and to obtain a spectrum of the sample based on the input light; and
a data transfer device configured to transfer the spectrum to a spectrum analyzer and to receive a result associated with the sample from the spectrum analyzer.

2. The portable laboratory device of claim 1, wherein the spectrometer comprises a micro-electro-mechanical systems (MEMS) interferometer and the at least one light source comprises at least one infrared light source.

3. The portable laboratory device of claim 1, wherein the data transfer device comprises a wireless transceiver configured to communicate with the spectrum analyzer.

4. The portable laboratory device of claim 1, further comprising:
the spectrum analyzer, wherein the data transfer device comprises a bus configured to transfer the spectrum to the spectrum analyzer.

5. The portable laboratory device of claim 1, wherein the spectrum analyzer comprises an artificial intelligence engine configured to produce the result from the spectrum.

6. The portable laboratory device of claim 5, wherein the spectrum comprises a measured absorption spectra and the artificial intelligence model is configured to detect one or more analytes from absorption signals of the measured absorption spectra in a near-infrared frequency range.

7. The portable laboratory device of claim 5, wherein the sample head is configured to receive a media containing the sample, and the artificial intelligence engine is configured to produce the result based on the media.

8. The portable laboratory device of claim 5, wherein the artificial intelligence engine comprises a plurality of calibration models, each constructed for a respective media type of a plurality of media types, and further comprising:
an input device configured to select a calibration model of the plurality of calibration models for a media type of the plurality of media types corresponding to the media containing the sample.

9. The portable laboratory device of claim 1, wherein the structure of the sample head comprises a tool coupled to a housing of the portable laboratory device and configured to facilitate application of the sample to the sample head.

10. The portable laboratory device of claim 1, wherein the structure of the sample head comprises a hole configured to align the sample with an optical window of the optical measurement device.

11. The portable laboratory device of claim 10, wherein the structure of the sample head further comprises a cavity configured to receive a cover slip on which the sample is placed, the cavity being positioned over the hole.

12. The portable laboratory device of claim 11, wherein the cover slip comprises a frame in which the sample is placed.

13. The portable laboratory device of claim 11, wherein the cover slip comprises a functionalized cover slip with receptors configured to bind with an analyte in the sample.

14. The portable laboratory device of claim 10, wherein the cavity comprises a first cavity configured to receive a first cover slip and a second cavity positioned over the first cavity configured to receive a second cover slip to contain the sample between the first cover slip and the second cover slip.

15. The portable laboratory device of claim 14, wherein the second cavity is rotated with respect to the first cavity.

16. The portable laboratory device of claim 14, wherein the first cavity and the second cavity each comprise an inclination angle with respect to a plane of the optical window of the optical measurement device.

17. The portable laboratory device of claim 10, wherein the structure of the sample head is moveable from a first position to receive the sample and a second position above the optical window of the optical measurement device.

18. The portable laboratory device of claim 1, wherein the sample head further comprises a cover configured to be positioned over the structure of the sample head, wherein the cover comprises a top surface and a bottom surface opposite the structure.

19. The portable laboratory device of claim 18, wherein the bottom surface of the cover comprises a reflecting surface or a reference material.

20. The portable laboratory device of claim 18, wherein the cover comprises a transmission mode light source of the at least one light source configured to direct the incident light towards the sample in a transmission mode.

21. The portable laboratory device of claim 20, wherein the cover comprises at least one reflector configured to direct the incident light towards the sample.

22. The portable laboratory device of claim 20, wherein the at least one light source further comprises a plurality of light sources arranged to direct the incident light towards the sample in a reflection mode simultaneously to the transmission mode or sequentially with respect to the transmission mode.

23. The portable laboratory device of claim 1, wherein the structure of the sample head comprises a well plate array configured to receive a plurality of samples and further comprising:
a motorized stage configured to automate measurement of the plurality of samples by the optical measurement device.

24. The portable laboratory device of claim 1, further comprising:
a first reflector positioned under the sample; and
a second reflector positioned over the sample opposite the first reflector, wherein the first reflector and the second reflector are configured to direct the incident light multiple times through the sample to produce the input light.

25. The portable laboratory device of claim 24, further comprising:
a third reflector configured to receive the incident light and to direct the incident light toward the second reflector; and
a fourth reflector configured to receive the input light and to direct the input light to the spectrometer.

26. The portable laboratory device of claim 24, wherein the first reflector and the second reflector comprise respective flat reflectors, respective curved reflectors, or respective arrays of corner reflectors.

27. The portable laboratory device of claim 24, further comprising:
a multi-pass cell comprising the first reflector and the second reflector.

28. The portable laboratory device of claim 1, wherein the structure of the sample head comprises a guiding spacer attached to a housing comprising the optical measurement device, wherein the guiding spacer is configured to guide insertion of the sample into the sample head.

29. The portable laboratory device of claim 28, wherein the guiding spacer is configured to receive a cuvette in which the sample is inserted.

30. The portable laboratory device of claim 28, further comprising:
a first slide on which the sample is positioned;
a second slide positioned on the guiding spacer above the first slide; and
a material slab positioned on the second slide.

31. The portable laboratory device of claim 30, wherein the first slide comprises a plurality of wells, each configured to receive a respective sample of a plurality of samples including the sample.

32. The portable laboratory device of claim 30, wherein the guiding spacer comprises a hole configured to facilitate application of the sample on the first slide.

33. The portable laboratory device of claim 30, further comprising:
a motor configured to translate the first slide to obtain the spectrum of the sample.

34. The portable laboratory device of claim 1, further comprising:
a switch coupled to the least one light source to switch on the at least one light source to dry the sample and produce a dried sample, wherein the spectrometer is configured to obtain the spectrum of the dried sample.

35. The portable laboratory device of claim 1, further comprising:
an excitation element configured to control one or more physical properties of the sample.

36. The portable laboratory device of claim 1, further comprising:
a display for displaying the result.

37. The portable laboratory device of claim 1, wherein the structure of the sample head is configured to receive a cuvette holder containing a cuvette within which the sample is inserted.

38. The portable laboratory device of claim 1, wherein the structure of the sample head is configured to receive an adapter containing a cuvette, the adapter being attached to a vial containing the sample that is inserted into the cuvette via capillary force.
